(19) United States
(12) Patent Application Publication
(10) Pub. No.: US 2026/0296004 A1
(43) Pub. Date: Oct. 1, 2026

(54) LIQUID EJECTING HEAD AND LIQUID EJECTING APPARATUS

(71) Applicant: SEIKO EPSON CORPORATION, Tokyo (JP)

(72) Inventors: Akira MIYAGISHI, SHIOJIRI-SHI (JP); Nobuaki ITO, SUWA-SHI (JP)

(21) Appl. No.: 19/574,536

(22) Filed: Mar. 23, 2026

(30) Foreign Application Priority Data
Mar. 25, 2025 (JP) 2025-050727

(51) Int. Cl. B41J 2/045; B41J 2/14

(52) U.S. Cl. CPC B41J 2/04581; B41J 2/14233; B41J 2002/14491; B41J 2202/11

(57) ABSTRACT

There are provided a plurality of nozzles arranged in a first direction; a first piezoelectric element; a second piezoelectric element; pressure chambers in each of which a pressure for jetting liquid from each of the nozzles is applied when the first piezoelectric element is driven; and detection chambers in each of which a residual vibration of the pressure of the liquid applied in each of the pressure chambers is detected by the second piezoelectric element, and, in a plan view, a width of a second active portion in the first direction is larger than a width of a first active portion in the first direction, the second active portion being an active portion of the second piezoelectric element, the first active portion being an active portion of the first piezoelectric element.

### CROSS TO THE RELATED APPLICATION

The present application is based on, and claims priority from JP Application Serial Number 2025-050727, filed Mar. 25, 2025, the disclosure of which is hereby incorporated by reference herein in its entirety.

### BACKGROUND

### Technical Field

The present disclosure relates to a liquid ejecting head that jets liquid from nozzles and a liquid ejecting apparatus including the liquid ejecting head, and particularly relates to an ink jet recording head that ejects ink as liquid and an ink jet recording apparatus.

### Related Art

A liquid ejecting apparatus represented by an ink jet recording apparatus, such as an ink jet printer or plotter, includes a liquid ejecting head capable of jetting liquid, such as ink stored in a cartridge, a tank, or the like, as liquid droplets. The liquid ejecting head includes nozzles that jet liquid, pressure chambers respectively communicating with the nozzles, and a driving element that generates pressure fluctuation in the liquid in the pressure chambers, and causes liquid droplets to be jetted from the nozzles by generating pressure fluctuation in the liquid in the pressure chambers using the driving element. In addition, the liquid ejecting head can determine clogging of the nozzles with foreign matter or thickening of the liquid by detecting residual vibration generated in the liquid in the pressure chambers after the liquid is jetted (for example, refer to JP-A-2019-147363).

However, in JP-A-2019-147363, since the driving for jetting the liquid and the detection of the residual vibration after the liquid is jetted are performed with the same piezoelectric elements and the same pressure chambers, when the residual vibration is to be detected while the liquid is jetted, there is a problem in that the driving frequency for jetting the liquid is limited and a sufficient throughput cannot be obtained.

For this reason, it is considered that the pressure chambers and the piezoelectric elements with which the detection of the residual vibration is performed are provided separately from the pressure chambers and the piezoelectric elements with which the jetting of the liquid is performed, but the structure of the piezoelectric elements with which the detection in such a case is performed is not sufficiently examined, and there is a problem in that it is not possible to perform efficient detection.

### SUMMARY

According to an aspect of the present disclosure to solve the above problems, there is provided a liquid ejecting head including: a plurality of nozzles arranged in a first direction; a first piezoelectric element; a second piezoelectric element; pressure chambers in each of which a pressure for jetting liquid from each of the nozzles is applied when the first piezoelectric element is driven; and detection chambers in each of which a residual vibration of the pressure of the liquid applied in each of the pressure chambers is detected by the second piezoelectric element, wherein, in a plan view, a width of a second active portion in the first direction is larger than a width of a first active portion in the first direction, the second active portion being an active portion of the second piezoelectric element, the first active portion being an active portion of the first piezoelectric element.

According to another aspect of the present disclosure, there is provided a liquid ejecting head including: a plurality of nozzles arranged in a first direction; a first piezoelectric element; a second piezoelectric element; pressure chambers in each of which a pressure for jetting liquid from each of the nozzles is applied when the first piezoelectric element is driven; and detection chambers in each of which a residual vibration of the pressure of the liquid applied in each of the pressure chambers is detected by the second piezoelectric element, wherein, in a plan view, an area of the second active portion that is an active portion of the second piezoelectric element is larger than an area of a first active portion that is an active portion of the first piezoelectric element.

According to still another aspect of the present disclosure, there is provided a liquid ejecting apparatus including: the liquid ejecting head according to any one of the above aspects; and a liquid storage portion that supplies liquid to the liquid ejecting head.

### BRIEF DESCRIPTION OF THE DRAWINGS

FIG. 1 is an exploded perspective view of a liquid ejecting head according to a first embodiment.

FIG. 2 is a plan view of a pressure chamber substrate and a communication plate according to the first embodiment.

FIG. 3 is a cross-sectional view of the liquid ejecting head according to the first embodiment.

FIG. 4 is a plan view of a first piezoelectric element, a second piezoelectric element, and the pressure chamber substrate according to the first embodiment.

FIG. 5 is a cross-sectional view of the first piezoelectric element and the pressure chamber substrate according to the first embodiment.

FIG. 6 is a cross-sectional view of the second piezoelectric element and the pressure chamber substrate according to the first embodiment.

FIG. 7 is a cross-sectional view of the first piezoelectric element and the pressure chamber substrate according to the first embodiment.

FIG. 8 is a cross-sectional view of the second piezoelectric element and the pressure chamber substrate according to the first embodiment.

FIG. 9 is a plan view of a first piezoelectric element, a second piezoelectric element, and a pressure chamber substrate according to a second embodiment.

FIG. 10 is a view showing a schematic configuration of a liquid ejecting apparatus according to an embodiment.

### DESCRIPTION OF EMBODIMENTS

The present disclosure will be described in detail below based on embodiments. However, the following description merely shows an aspect of the present disclosure, and can be appropriately changed within the scope of the present disclosure. In the drawings, the same reference numerals denote the same members, and the description thereof will be appropriately omitted. In each drawing, X, Y, and Z represent three spatial axes that are orthogonal to each other. In the present specification, directions along these axes are referred to as an X direction, a Y direction, and a Z direction. In each drawing, a direction indicated by an arrow is a positive (+) direction, and a direction opposite to the arrow is a negative (-) direction. The Z direction indicates a vertical direction, a +Z direction indicates a vertically downward direction, and a -Z direction indicates a vertically upward direction. Furthermore, the directions of the three spatial axes, which are not limited to the positive direction or the negative direction, will be described as an X-axis direction, a Y-axis direction, and a Z-axis direction. In each of the following embodiments, as an example, a "first direction" is the X-axis direction, and an "ejection direction" is the +Z direction. Furthermore, "down" refers to the +Z direction, and "up" refers to the -Z direction. Furthermore, viewing in a direction along the Z-axis direction is referred to as "plan view".

### First Embodiment

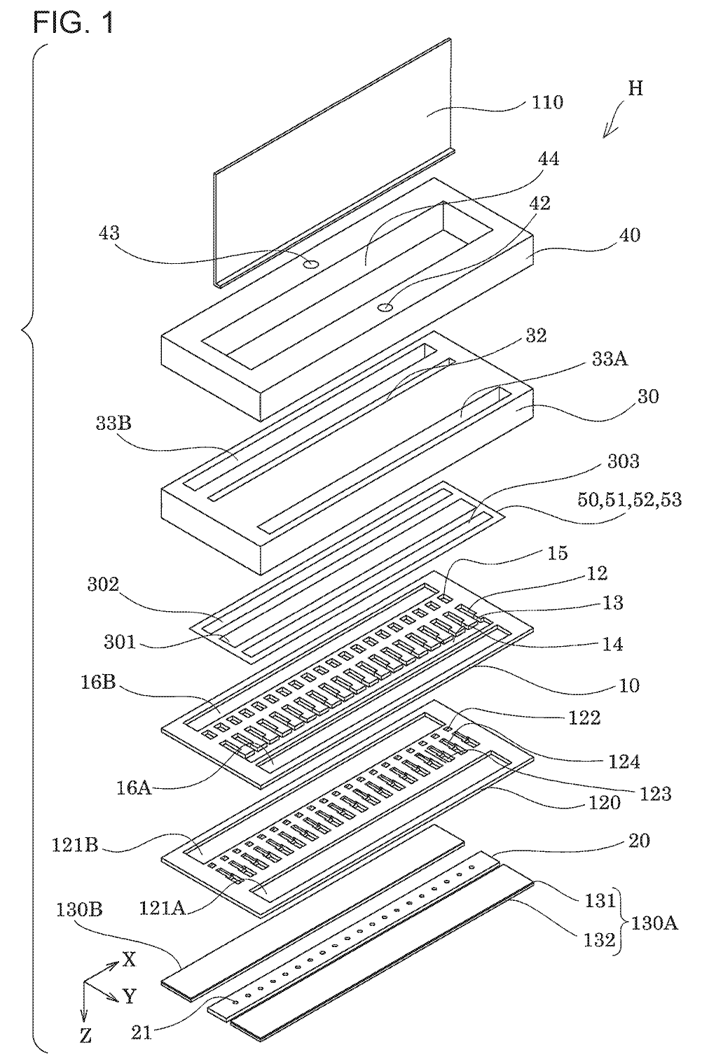

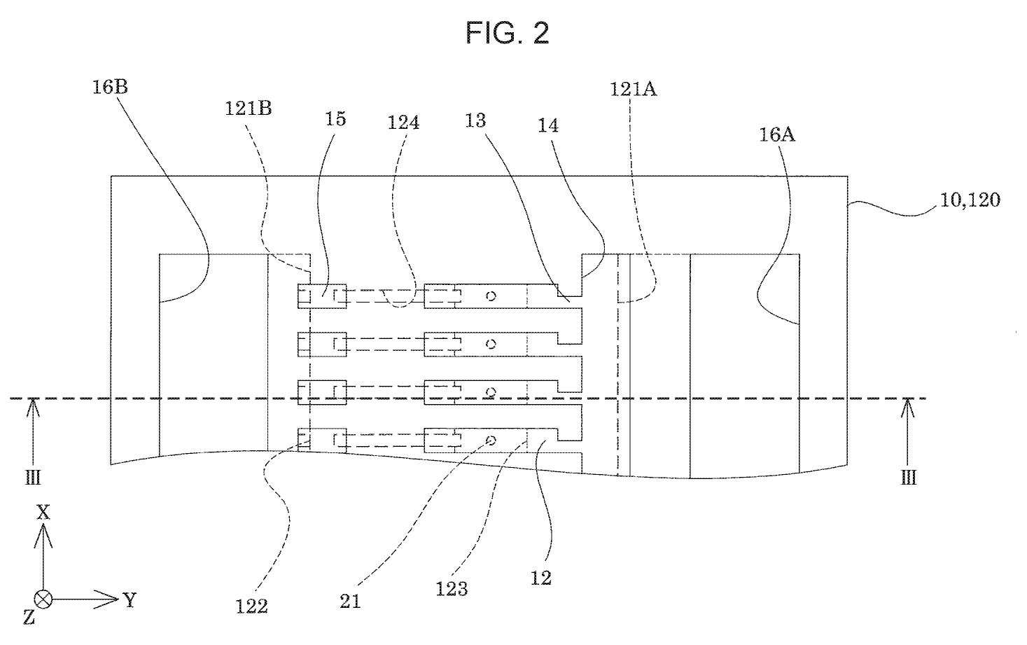

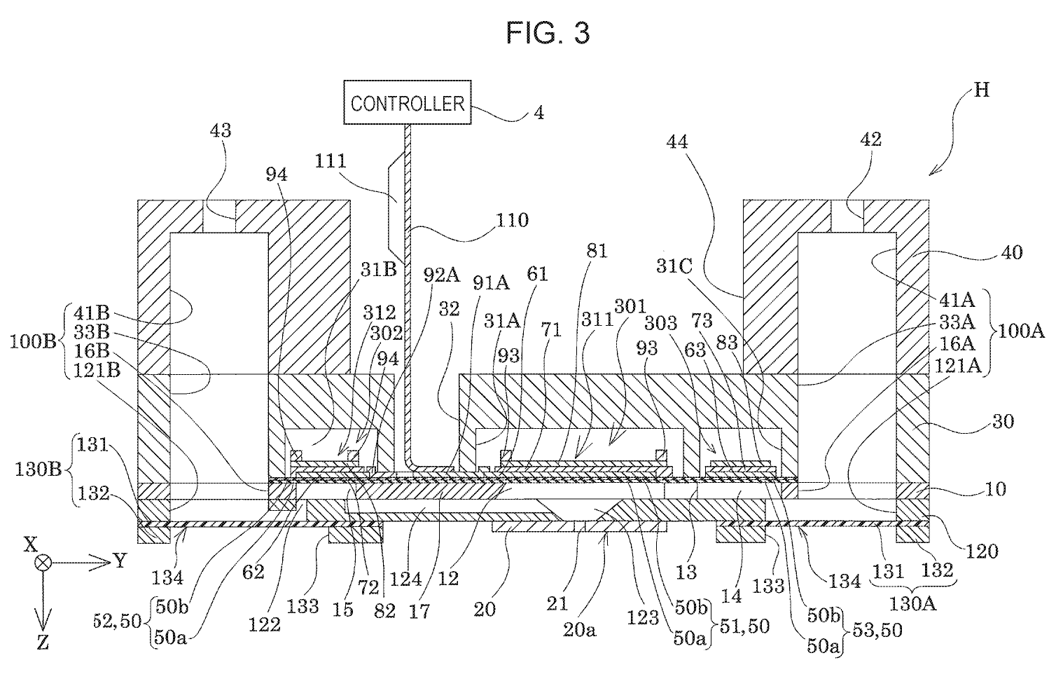

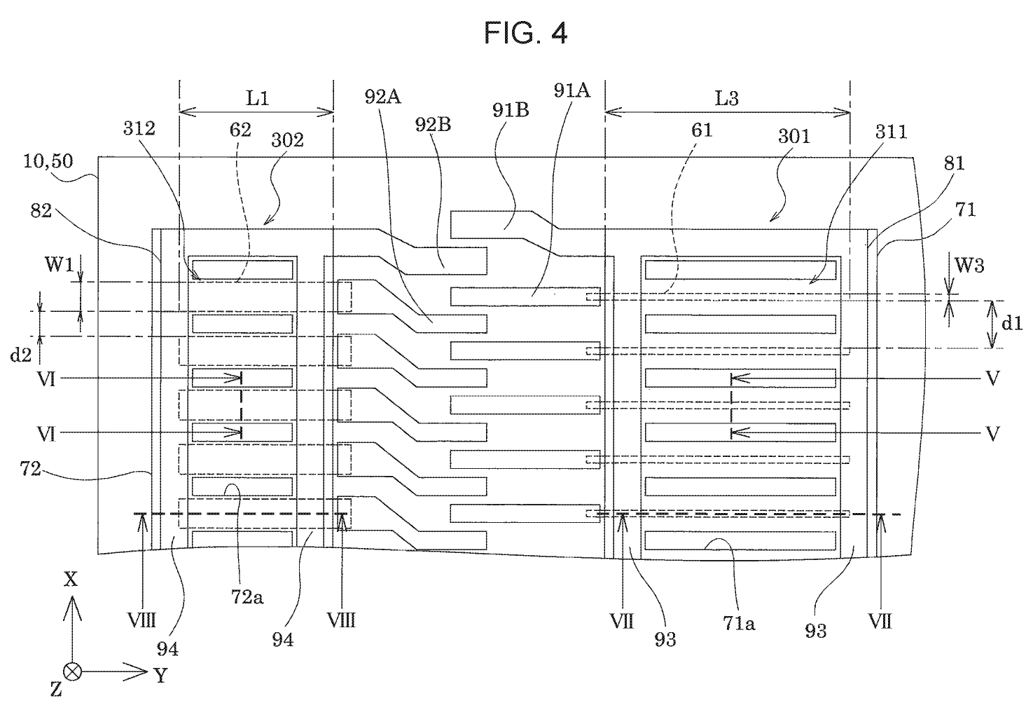

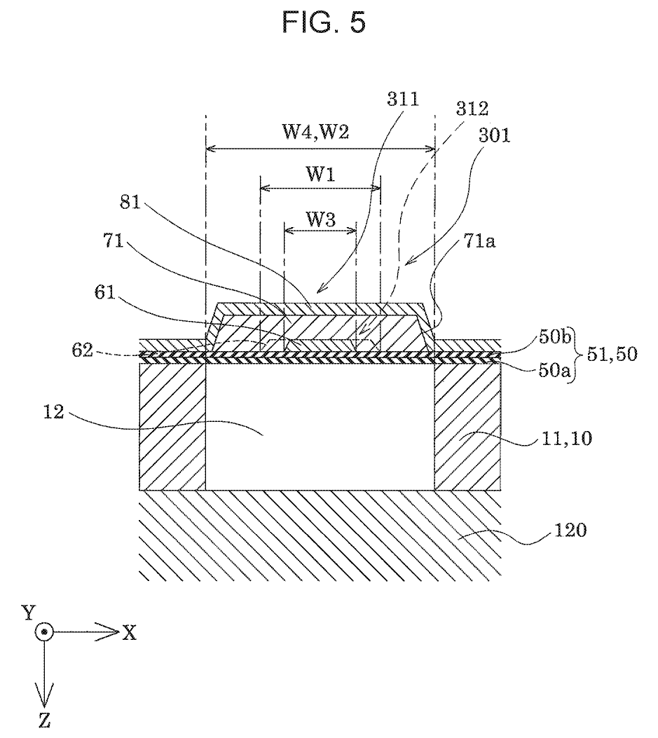

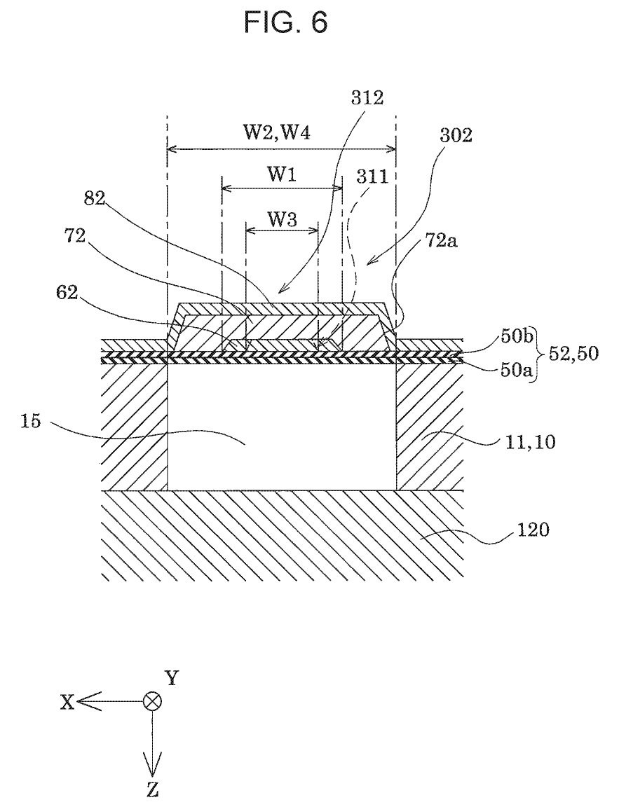

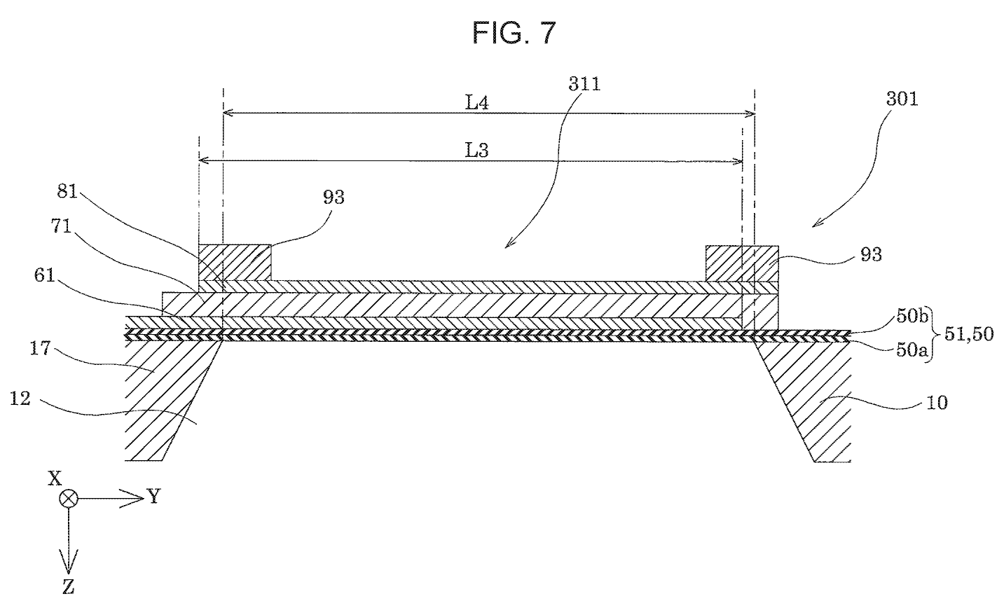

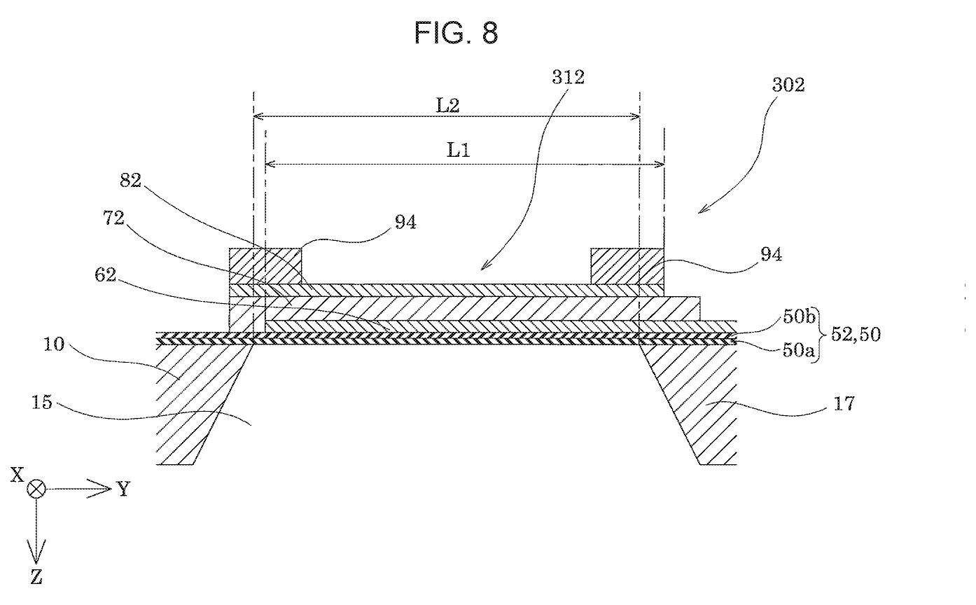

FIG. 1 is an exploded perspective view of a liquid ejecting head H according to a first embodiment of the present disclosure. FIG. 2 is a plan view of a pressure chamber substrate 10 and a communication plate 120 as viewed in the +Z direction. FIG. 3 is a cross-sectional view of the liquid ejecting head H taken along line III-III in FIG. 2. FIG. 4 is a plan view of a first piezoelectric element 301, a second piezoelectric element 302, and the pressure chamber substrate 10 when viewed in the +Z direction. FIG. 5 is a cross-sectional view taken along line V-V in FIG. 4. FIG. 6 is a cross-sectional view taken along line VI-VI in FIG. 4. FIG. 7 is a cross-sectional view taken along line VII-VII in FIG. 4. FIG. 8 is a cross-sectional view taken along line VIII-VIII in FIG. 4.

The liquid ejecting head H is configured as a head for ejecting ink in a printer. The ink is guided to the liquid ejecting head H, and a part of the ink is ejected from nozzles 21 toward, for example, an outside printing medium. Since the ink is circulated, the ink that has not been ejected from the nozzles 21 is discharged from the liquid ejecting head H. Therefore, in the present specification, the terms "supply side" and "discharge side" may be used. The "supply side" indicates an upstream of pressure chambers which will be described later with respect to flow paths of liquid. Furthermore, a component related to the upstream of the pressure chambers may be referred to as "supply side". The "discharge side" indicates a downstream of pressure chambers 12 with respect to the flow paths of the liquid.

The "discharge side" does not include the nozzles 21 to be described later. Furthermore, a component related to the downstream of the pressure chambers 12 may be referred to as "discharge side". The "discharge side" may also be referred to as "collection side". The liquid is not limited to ink, and the liquid ejecting head H can be configured to eject other liquids.

As shown in the drawings, the liquid ejecting head H includes a nozzle plate 20, the communication plate 120, the pressure chamber substrate 10, a protective substrate 30, and a case 40 in order toward the -Z direction.

The pressure chamber substrate 10 is made of, for example, a silicon substrate, a glass substrate, an SOI substrate, or various ceramic substrates.

In the pressure chamber substrate 10, a plurality of pressure chambers 12 are disposed side by side along the X-axis direction. The plurality of pressure chambers 12 are disposed on a straight line along the X-axis direction such that the positions thereof become the same in the Y-axis direction. Two pressure chambers 12 adjacent to each other in the X-axis direction are partitioned by a partition wall 11.

Each of the plurality of pressure chambers 12 is formed by a through hole that passes through the pressure chamber substrate 10 in the Z-axis direction from a surface of the pressure chamber substrate 10 facing the -Z direction to a surface thereof facing the +Z direction and is partially defined on a surface of the communication plate 120 facing the -Z direction. Here, the "through hole" refers to a space defined by a side surface that connects the surface of the pressure chamber substrate 10 facing the -Z direction to the surface thereof facing the +Z direction. The side surface may be a surface inclined with respect to the Z-axis direction, that is, the through hole may be defined on the inclined surface.

In addition, the pressure chamber substrate 10 includes ink supply paths 13 for the respective pressure chambers 12, each of which communicates with one end portion of the pressure chamber 12 in a +Y direction. The ink supply path 13 is defined as a through hole passing through the pressure chamber substrate 10 in the Z-axis direction, is formed to have a width narrower than that of the pressure chamber 12 in the X-axis direction and maintains a constant flow path resistance of the ink which flows into the pressure chamber 12 from the upstream. That is, the ink supply path 13 functions as a so-called throttle portion. The ink supply path 13 is not limited to the configuration in which the width in the X-axis direction is narrowed, and the height in the Z-axis direction may be narrowed. The pressure chamber 12 refers to a portion to a connection port connected to the ink supply path 13. The surface of the pressure chamber 12 in the -Z direction is defined by a first diaphragm 51, and the surface of the ink supply path 13 in the -Z direction is defined by the diaphragm.

In addition, the pressure chamber substrate 10 includes an absorption chamber 14 communicating with an end portion opposite to the one end portion of the ink supply path 13 communicating with the pressure chamber 12 in the Y-axis direction, that is, an end portion in the +Y direction. The absorption chamber 14 is defined as a through hole passing through the pressure chamber substrate 10 in the Z-axis direction. That is, the pressure chamber 12 and the absorption chamber 14 communicate with each other via the ink supply path 13. The absorption chamber 14 is provided continuously along the X-axis direction over the plurality of ink supply paths 13. A surface of the absorption chamber 14 in the -Z direction is defined by a third diaphragm 53. Such an absorption chamber 14 functions as a damper for absorbing the vibration of the ink. Note that the absorption chamber 14 is not necessarily required, and the absorption chamber 14 need not be provided.

In addition, the pressure chamber substrate 10 includes detection chambers 15 at positions in the -Y direction, which is opposite in the Y-axis direction to the ink supply paths 13 with respect to the pressure chambers 12, the positions being separated from the pressure chambers 12 in the Y-axis direction. Each of the detection chambers 15 is defined as a through hole passing through the pressure chamber substrate 10 in the Z-axis direction and is defined on a surface of the communication plate 120 facing the -Z direction. That is, the pressure chamber substrate 10 includes a partition wall 17 that is provided between the pressure chambers 12 and the detection chambers 15 and defines the side surfaces of the pressure chambers 12 and the detection chambers 15 in the Y-axis direction. A plurality of detection chambers 15 are disposed side by side along the X-axis direction. That is, the plurality of detection chambers 15 are disposed on a straight line along the X-axis direction so as to be at the same position with respect to the Y-axis direction. Two detection chambers 15 adjacent to each other in the X-axis direction are partitioned by the partition wall 11. In the present embodiment, as shown in FIGS. 5 and 6, a width W2 in the X-axis direction of the upper surface of the respective detection chambers 15 facing the -Z direction is the same as a width W4 in the X-axis direction of the upper surface of the respective pressure chambers 12 facing the -Z direction, and the detection chambers 15 are disposed at the same pitch as the pitch of the pressure chambers 12 in the X-axis direction. As shown in FIGS. 7 and 8, a length L2 in the Y-axis direction of the upper surface of the respective detection chambers 15 facing the -Z direction is smaller than a length L4 in the Y-axis direction of the upper surface of the respective pressure chambers 12 facing the -Z direction. That is, in a plan view as viewed in the +Z direction, the area of the upper surface of the respective detection chambers 15 facing the -Z direction is smaller than the area of the upper surface of the respective pressure chambers 12 facing the -Z direction. In the present embodiment, since the pressure chambers 12 and the detection chambers 15 are provided to pass through the pressure chamber substrate 10 in the Z-axis direction, the pressure chambers 12 and the detection chambers 15 have the same height in the Z-axis direction. Therefore, the volume of the respective detection chambers 15 is smaller than the volume of the respective pressure chambers 12.

As a matter of course, the length L2 of the detection chamber 15 may be the same as the length L4 of the pressure chamber 12. In this case, by making the width W2 of the detection chamber 15 in the X-axis direction smaller than the width W4 of the pressure chamber 12 in the X-axis direction, the area of the upper surface of the detection chamber 15 facing the -Z direction when viewed in a plan view in the +Z direction may be made smaller than the area of the upper surface of the pressure chamber 12 facing the -Z direction to make the volume of the detection chamber 15 smaller than the volume of the pressure chamber 12. As a matter of course, the width in the X-axis direction and the length in the Y-axis direction of the detection chamber 15 may be the same as those of the pressure chamber 12 to make the area and the volume of the detection chamber 15 when viewed in a plan view in the +Z direction the same as those of the pressure chamber 12.

Incidentally, the width W2 in the X-axis direction and the length L2 in the Y-axis direction of the detection chamber 15, and the width W4 in the X-axis direction and the length L4 in the Y-axis direction of the pressure chamber 12 are the maximum dimensions on the surface defined by the second diaphragm 52 and the first diaphragm 51, respectively, that is on the upper surface facing the -Z direction.

In the pressure chamber substrate 10, on both end portions in the Y-axis direction, that is, on both outer sides with respect to the pressure chambers 12, the absorption chamber 14, and the detection chambers 15, there are formed flow paths 16A and 16B respectively constituting parts of common liquid chambers 100A and 100B with which the plurality of pressure chambers 12 communicate in common. In the present embodiment, the supply-side common liquid chamber 100A and the discharge-side common liquid chamber 100B are formed in the liquid ejecting head H, and the flow path 16A constituting a part of the supply-side common liquid chamber 100A and the flow path 16B constituting a part of the discharge-side common liquid chamber 100B are provided in the pressure chamber substrate 10. These flow paths 16A and 16B are provided to pass through the pressure chamber substrate 10 in the Z-axis direction.

The communication plate 120 and the nozzle plate 20 are sequentially stacked on the surface of the pressure chamber substrate 10 facing the +Z direction.

The communication plate 120 includes a flow path 121A constituting a part of the common liquid chamber 100A and a flow path 121B constituting a part of the common liquid chamber 100B. The flow path 121A is a flow path constituting a part of the supply-side common liquid chamber 100A and is provided to pass through the communication plate 120 in the Z-axis direction at a position overlapping the flow path 16A of the pressure chamber substrate 10 when viewed in the Z-axis direction. In addition, the flow path 121A extends in the -Y direction to a position overlapping an end portion of the absorption chamber 14 in the +Y direction when viewed in the Z-axis direction. Accordingly, the flow path 121A communicates with the absorption chamber 14 of the pressure chamber substrate 10 in the Z-axis direction at the end portion in the -Y direction. The flow path 121B is a flow path constituting a part of the discharge-side common liquid chamber 100B and is provided to pass through the communication plate 120 in the Z-axis direction at a position overlapping the flow path 16B of the pressure chamber substrate 10 when viewed in the Z-axis direction. In addition, the flow path 121B extends in the +Y direction to a position overlapping an end portion of the detection chamber 15 in the -Y direction when viewed in the Z-axis direction. The portion of the flow path 121B, which extends in the +Y direction does not pass through the communication plate 120 in the Z-axis direction and has a recessed shape which is open on a surface facing the +Z direction. In addition, the communication plate 120 is provided with discharge communication paths 122 each of which communicates the detection chamber 15 with the flow path 121B, and the ink in the detection chamber 15 is discharged to the flow path 121B via the discharge communication path 122.

In addition, the communication plate 120 includes communication paths 123 through which the pressure chambers 12 and the nozzles 21 individually communicate with each other, and collection paths 124 for collecting the ink in the communication paths 123 and the pressure chambers 12 to the outside of the liquid ejecting head H.

Each of the communication paths 123 is defined as a through hole passing through the communication plate 120 in the Z-axis direction. For this reason, an end portion of the communication path 123 in the -Z direction communicates with the pressure chamber 12, and an end portion thereof in the +Z direction communicates with the nozzle 21. A plurality of such communication paths 123 are provided independently for the respective pressure chambers 12, that is, independently in the X-axis direction.

Each of the communication paths 123 is provided such that the width in the Y-axis direction gradually decreases toward the +Z direction. That is, both side surfaces of the communication path 123 in the Y-axis direction are inclined surfaces that are inclined in the Z-axis direction. Specifically, the side surface of the communication path 123 in the -Y direction is formed of an inclined surface that is inclined in the -Z direction while extending in the -Y direction. In addition, the side surface of the communication path 123 in the +Y direction is formed of an inclined surface that is inclined in the +Z direction while extending in the -Y direction.

Each of the collection paths 124 is defined by a recessed portion, the recessed portion being recessed in the +Z direction from the surface of the communication plate 120 facing the -Z direction and being connected to the communication path 123. Note that the "recessed portion" in the present specification refers to a space which is open on one surface of the substrate and is not open on the other surface opposite to the one surface, that is, a space provided in a part of the thickness without passing through the substrate in the thickness direction. The collection path 124 of the present embodiment is open on the surface of the communication plate 120 facing the -Z direction and is not open on the surface of the communication plate 120 facing the +Z direction, that is, the collection path 124 is provided in a part of the thickness in the Z-axis direction without passing through the communication plate 120 in the Z-axis direction. For this reason, the recessed portion which forms the collection path 124 is not open on the surface of the communication plate 120 facing the +Z direction. That is, the collection paths 124 are not defined by the nozzle plate 20 that is fixed to the surface in the +Z direction of the communication plate 120. A plurality of such collection paths 124 are provided independently for the respective pressure chambers 12, that is, independently in the X-axis direction. In addition, the collection path 124 extends in the -Y direction from a connection port with the communication path 123. That is, when viewed in the +Z direction, the absorption chamber 14 and the ink supply path 13 that constitute the supply path, the pressure chamber 12 and the communication path 123, and the collection path 124 are disposed side by side in the -Y direction.

One end of such a collection path 124 in the +Y direction communicates with the communication path 123, and the other end of the collection path 124 in the -Y direction extends to a position overlapping an end portion of the detection chamber 15 in the +Y direction when viewed in the Z-axis direction.

The width of the collection path 124 in the X-axis direction may be smaller than that of the communication path 123 or may be the same as that of the communication path 123. By making the width of the collection path 124 in the X-axis direction smaller than that of the communication path 123, it is possible to make the flow path cross-sectional area of the collection path 124 small, and it is possible to increase the flow speed of the ink flowing in the collection path 124. Thus, the air bubbles in the collection path 124 can be easily discharged from the collection path 124 to the outside. By making the width of the collection path 124 in the X-axis direction the same as the width of the communication path 123, a step due to the difference in width is not formed at a connecting portion connecting the communication path 123 and the collection path 124, and the occurrence of the discharge failure of the air bubbles due to the air bubbles being caught in the step can be suppressed.

In addition, both sides of the communication path 123 in the X-axis direction are defined by the partition wall 11, and a surface in the +Z direction is defined by the nozzle plate 20.

In addition, the collection path 124 is disposed at a position overlapping the pressure chamber 12 when viewed in the +Z direction, and the collection path 124 is connected to the pressure chamber 12 in a region overlapping the pressure chamber 12. That is, since the collection path 124 is provided to be open on the surface of the communication plate 120 facing the -Z direction and the pressure chamber 12 is extended further in the -Y direction than the communication path 123, an opening of the collection path 124 on the surface of the communication plate 120 facing the -Z direction and a portion of the pressure chamber 12 extended in the -Y direction more than the communication path 123 communicate with each other in the Z-axis direction. In this way, by directly connecting the collection path 124 to the pressure chamber 12, even in a case where air bubbles enter the pressure chamber 12 from the communication path 123, it is possible to discharge the air bubbles in the pressure chamber 12 to the collection path 124. Incidentally, if the collection path 124 is connected only to the communication path 123 without being directly connected to the pressure chamber 12, it is necessary for the air bubbles that have entered the pressure chamber 12 to move to the collection path 124 via the communication path 123, which is difficult.

The nozzle plate 20 is a plate-shaped member which is joined to a surface of the communication plate 120 which is opposite to the pressure chamber substrate 10, that is, which faces the +Z direction. In the nozzle plate 20, a plurality of nozzles 21 are formed, each of which communicates with each of the pressure chambers 12 via each of the communication paths 123. In the present embodiment, the plurality of nozzles 21 are disposed side by side in a row in the X-axis direction. As such a nozzle plate 20, a silicon substrate or an SOI substrate is preferably used. The material of the nozzle plate 20 is not limited to this, and a glass substrate, any kind of ceramic substrates, a metal substrate such as a stainless-steel substrate, an organic material such as a polyimide resin, or the like may be used. In the present embodiment, a surface of the nozzle plate 20 facing the +Z direction on which the nozzles 21 are open is referred to as a nozzle surface 20a.

With such a configuration, the ink in the common liquid chamber 100A is supplied to the nozzles 21 via the absorption chamber 14, the ink supply paths 13, the pressure chambers 12, and the communication paths 123. The ink that has not been ejected from the nozzles 21 in the pressure chambers 12 and the communication paths 123 is collected in the common liquid chamber 100B via the collection paths 124, the detection chambers 15, and the discharge communication paths 122. That is, in the present embodiment, "individual supply paths" which individually communicate with the nozzles 21 and supply the ink to the nozzles 21 include the ink supply paths 13, the pressure chambers 12, and the communication paths 123. In addition, "individual collection paths" which individually communicate with the nozzles 21 and collects ink that has not been ejected from the nozzles 21 include the communication paths 123, the pressure chambers 12, the collection paths 124, and the detection chambers 15. If the discharge communication paths 122 are independently provided for the respective detection chambers 15, the discharge communication paths 122 are included in the individual collection paths. Alternatively, the discharge communication path 122 may be continuously provided over the plurality of detection chambers 15, that is, over the X-axis direction. In the present embodiment, the individual supply paths, the individual discharge paths, and the nozzles 21 are collectively referred to as "individual flow paths". Furthermore, a flow path with which a plurality of individual flow paths communicates in common is referred to as a "common flow path". In the present embodiment, the common liquid chambers 100A and 100B are provided as the common flow paths. In this way, since the detection chambers 15 and the pressure chambers 12 constitute a part of the individual flow paths instead of the common flow paths, the residual vibration of the pressure chambers 12 can be detected individually by the respective detection chambers 15, and the ejection failure of the respective nozzles 21 can be individually detected. In addition, since each of the detection chambers 15 constitutes a part of the individual collection path, it is possible to shorten the flow path length of the individual supply path compared to a case where the detection chamber 15 is provided so as to constitute a part of the individual supply path. Therefore, it is possible to shorten the flow path length of the individual supply paths, to reduce the pressure loss, and to suppress the occurrence of the supply failure of the ink to the pressure chambers 12.

In the present embodiment, since the collection path 124 is connected to the communication path 123 which is further in the +Z direction than the pressure chamber 12, it is possible to discharge the air bubbles to the collection path 124 before the air bubbles which have been drawn from the nozzle 21 and entered the communication path 123 or the air bubbles which have entered the communication path 123 from the ink supply path 13 rise to the pressure chamber 12 due to the buoyancy. Therefore, it is possible to improve the air-bubble discharging performance by the collection path 124.

The first piezoelectric element 301, the second piezoelectric element 302, and a third piezoelectric element 303 are stacked on the surface of the pressure chamber substrate 10 facing the -Z direction via the first diaphragm 51, the second diaphragm 52, and the third diaphragm 53, respectively.

In the present embodiment, the first diaphragm 51, the second diaphragm 52, and the third diaphragm 53 have the same thickness, the same material, and the same stacked structure. Therefore, hereinafter, in a case where the first diaphragm 51, the second diaphragm 52, and the third diaphragm 53 are not distinguished, they are referred to as a diaphragm 50. As a matter of course, the first diaphragm 51, the second diaphragm 52, and the third diaphragm 53 may have different stacked structures such as film thicknesses and materials.

The first diaphragm 51 includes, for example, an elastic film 50a made of silicon oxide and an insulating film 50b made of zirconium oxide provided on a surface of the elastic film 50a facing the -Z direction. In the present embodiment, the second diaphragm 52 and the third diaphragm 53 are provided to be continuous with the first diaphragm 51. That is, the second diaphragm 52 and the third diaphragm 53 include the elastic film 50a and the insulating film 50b. The diaphragm 50 may be formed of only the elastic film 50a, may be formed of only the insulating film 50b, or may have a configuration including another film in addition to the elastic film 50a and the insulating film 50b. In the diaphragm 50 provided on the surface of the pressure chamber substrate 10 facing the -Z direction, among openings of the surface of the pressure chamber substrate 10 facing the -Z direction, a portion covering the opening of the pressure chamber 12 is referred to as the first diaphragm 51, a portion covering the opening of the detection chamber 15 is referred to as the second diaphragm 52, and a portion covering the opening of the absorption chamber 14 is referred to as the third diaphragm 53. Note that the pressure chamber substrate 10 and the elastic film 50a which is a part of the diaphragm 50 may be integrally formed, and in this case, recessed portions as the pressure chambers 12, the ink supply paths 13, the absorption chamber 14, and the detection chambers 15 may be formed by etching in the -Z direction a surface of the pressure chamber substrate 10 facing the +Z direction. In this case, the bottom surface of the recessed portion is the elastic film 50a. In addition, the entire diaphragm 50 and the pressure chamber substrate 10 may be integrally formed.

Each of the first piezoelectric element 301, the second piezoelectric element 302, and the third piezoelectric element 303 includes electrodes on an upper surface of a piezoelectric body facing the -Z direction and a lower surface thereof facing the +Z direction, the piezoelectric body being formed of a piezoelectric material made of composite oxides having a perovskite structure represented by a general formula ABO₃. When a voltage is applied between the upper and lower electrodes, the piezoelectric body interposed between the two electrodes is deformed by the electrostrictive effect, and on the other hand, when a force that deforms the piezoelectric body from the outside is applied, a voltage is generated between the electrodes by the piezoelectric effect. In the present embodiment, the first piezoelectric element 301, the second piezoelectric element 302, and the third piezoelectric element 303 have roughly the same configuration. However, the first piezoelectric element 301 is used as a piezoelectric element that generates vibration in the first diaphragm 51 by applying a voltage between the electrodes, and the second piezoelectric element 302 is used as a piezoelectric element that generates pressure by vibration being applied to the second diaphragm 52 from the outside and thereby detects vibration. The third piezoelectric element 303 has the same configuration as the other piezoelectric elements but is not electrically connected to the upper and lower electrodes and is used as a mass for absorbing the pressure change of the ink in the absorption chamber 14. In the present embodiment, the first piezoelectric element 301, the second piezoelectric element 302, and the third piezoelectric element 303 are simultaneously formed of the same material. Thus, the manufacturing cost can be reduced. As a matter of course, the first piezoelectric element 301, the second piezoelectric element 302, and the third piezoelectric element 303 may be formed of different materials in different manufacturing processes.

First, the first piezoelectric element 301 will be described. The first piezoelectric element 301 includes a first lower electrode 61, a first piezoelectric layer 71, and a first upper electrode 81 which are sequentially stacked on the first diaphragm 51. Such a first piezoelectric element 301 is also referred to as a piezoelectric actuator and refers to a portion including the first lower electrode 61, the first piezoelectric layer 71, and the first upper electrode 81. A portion in which piezoelectric strain occurs in the first piezoelectric layer 71 when a voltage is applied between the first lower electrode 61 and the first upper electrode 81 is referred to as a first active portion 311. In contrast, a portion in which piezoelectric strain does not occur in the first piezoelectric layer 71 is referred to as a non-active portion. That is, the first active portion 311 refers to a portion where the first piezoelectric layer 71 is interposed between the first lower electrode 61 and the first upper electrode 81. In other words, the first active portion 311 refers to a portion where three of the first piezoelectric layer 71, the first lower electrode 61, and the first upper electrode 81 overlap in the Z-axis direction. In the present embodiment, the first active portion 311 is formed for each pressure chamber 12. That is, a plurality of first active portions 311 are formed in the first piezoelectric element 301. The plurality of first active portions 311 are disposed side by side along the X-axis direction. The plurality of first active portions 311 serve as driving elements that cause a pressure change in the ink in the pressure chambers 12. In general, one of the electrodes of the first active portions 311 is configured as an individual electrode which is independent for each first active portion 311, and the other electrode is configured as a common electrode which is common to the plurality of first active portions 311. In the present embodiment, the first lower electrode 61 is configured as the individual electrode, and the first upper electrode 81 is configured as the common electrode. In the first piezoelectric element 301, a portion facing the pressure chambers 12 in the Z-axis direction is referred to as a flexible portion, and an outer portion not facing the pressure chambers 12 in the Z-axis direction is referred to as a non-flexible portion.

Here, the first lower electrode 61 is divided for each pressure chamber 12 to be configured as individual electrodes which are independent for each first active portion 311. Each of the first lower electrodes 61 is formed to have a width narrower than the width of the pressure chamber 12 in the X-axis direction. That is, in the X-axis direction, the end portions of the first lower electrode 61 are located inside the region opposed to the pressure chamber 12. In addition, an end portion of the first lower electrode 61 in the -Y direction is disposed outside the pressure chamber 12. The end portion of the first lower electrode 61 in the -Y direction, which is disposed outside the pressure chamber 12, is not covered with the first piezoelectric layer 71, and is connected to a first individual lead electrode 91A which is a lead-out wiring.

The first piezoelectric layer 71 is provided continuously in the X-axis direction so as to have a predetermined width in the Y-axis direction. The first piezoelectric layer 71 has a first recessed portion 71a corresponding to each partition wall 11. The width of the respective first recessed portions 71a in the X-axis direction is equal to or wider than the width of the respective partition walls 11. In the present embodiment, the width of the first recessed portion 71a in the X-axis direction is wider than the width of the partition wall 11. Accordingly, since the rigidity of portions corresponding to both end portions of the pressure chamber 12 of the diaphragm 50 in the X-axis direction, that is, so-called arm portions of the diaphragm 50 is reduced, it is possible to improve the displacement efficiency of the first piezoelectric element 301. The first recessed portion 71a may be provided to pass through the first piezoelectric layer 71 in the Z-axis direction, which is the thickness direction, or may be provided to the middle of the thickness of the first piezoelectric layer 71 without passing through the first piezoelectric layer 71. That is, the first piezoelectric layer 71 may be completely removed from the bottom surface of the first recessed portion 71a, or a part of the first piezoelectric layer 71 may remain. In the present embodiment, the first recessed portion 71a is provided to pass through the first piezoelectric layer 71 in the Z-axis direction, and the bottom surface of the first recessed portion 71a is defined by the diaphragm 50.

The first upper electrode 81 is continuously provided over the surface of the first piezoelectric layer 71 facing the -Z direction and is configured as a common electrode common to the plurality of first active portions 311. The first upper electrode 81 is provided continuously over the X-axis direction so as to have a predetermined width in the Y-axis direction. The first upper electrode 81 is also provided on the inner surfaces of the first recessed portions 71a, that is, on the side surfaces of the first recessed portions 71a of the first piezoelectric layers 71 and on the diaphragm 50 which is the bottom surfaces of the first recessed portions 71a. As a matter of course, the first upper electrode 81 may be provided only on a part of the inner surfaces of the first recessed portions 71a and need not be provided over the entire surfaces of the first recessed portions 71a.

In the first piezoelectric element 301 as described above, both end portions of the first active portion 311 in the X-axis direction are defined by both end portions of the first lower electrode 61 in the X-axis direction. In addition, the end portion of the first active portion 311 in the -Y direction is defined by the end portion of the first upper electrode 81 in the -Y direction, and the end portion of the first active portion 311 in the +Y direction is defined by the end portion of the first lower electrode 61 in the +Y direction. The first lower electrode 61 is disposed at a position overlapping the center of the pressure chamber 12 in the X-axis direction. That is, the first active portion 311 is disposed at a position overlapping the center of the pressure chamber 12 in the X-axis direction. Similarly, the first active portion 311 is disposed at a position overlapping the center of the pressure chamber 12 in the Y-axis direction. The center of the pressure chamber 12 in the X-axis direction refers to an intersection of diagonal lines of the pressure chamber 12 in a plan view in which the opening of the pressure chamber 12 in the -Z direction is viewed in the +Z direction.

The first individual lead electrodes 91A serving as lead-out wirings are pulled out from the first lower electrodes 61, respectively. A first common lead electrode 91B serving as a lead-out wiring is led out from the first upper electrode 81. The first individual lead electrodes 91A and the first common lead electrode 91B are formed of the same layer but are formed so as to be electrically discontinuous. The first individual lead electrodes 91A and the first common lead electrode 91B are formed of an adhesion layer (not shown) and a conductive layer provided on a surface of the adhesion layer facing the -Z direction.

In addition, the first common lead electrode 91B includes first extension portions 93 respectively provided on the respective wall surfaces on both sides of the pressure chambers 12 in the Y-axis direction to extend over the boundary portion between the flexible portion and the non-flexible portion. The first extension portions 93 are partially provided on the first upper electrode 81 and are respectively provided at both ends of the first upper electrode 81 and the first piezoelectric layer 71 in the Y-axis direction. Each of the first extension portions 93 is provided continuously over the X-axis direction of the plurality of first active portions 311, and an end portion of each of the first extension portions 93 in the X-axis direction is continuous with the first common lead electrode 91B. That is, the first common lead electrode 91B including the first extension portions 93 is continuously disposed so as to surround the plurality of first active portions 311 in a plan view from the +Z direction. That is, the first extension portions 93 refer to two portions of the first common lead electrode 91B provided along the X-axis direction.

By providing the first extension portions 93 in this way, it is possible to suppress a voltage drop in the X-axis direction of the first upper electrode 81 and to suppress a decrease and variation in the ejection characteristics of the ink jetted from each nozzle 21. In particular, in the present embodiment, by respectively providing the first extension portions 93 at both end portions in the direction along the Y-axis of the first active portions 311, it is possible to increase the cross-sectional area along the YZ plane defined by the Y-axis and the Z-axis of the first extension portions 93, to make the electrical resistance value relatively small, and to effectively suppress the voltage drop. In addition, by providing each of the first extension portions 93 at a position overlapping the boundary between the flexible portion and the non-flexible portion when viewed in the +Z direction, it is possible to improve the rigidity of the boundary between the flexible portion and the non-flexible portion, and to suppress the destruction of the first piezoelectric layer 71 in the stress concentration of the boundary between the flexible portion and the non-flexible portion. In addition, in the direction along the Y axis, by respectively providing the first extension portions 93 on both end portions where the deformation amount of the first active portions 311 is relatively small and not providing the first extension portions 93 in the center portion where the deformation amount is relatively large, it is possible to suppress the first extension portions 93 from inhibiting the deformation of the first active portions 311 and to suppress a significant decrease in the deformation amount of the first piezoelectric element 301.

A flexible substrate 110 which is a wiring substrate having flexibility is connected to end portions of each of the first individual lead electrodes 91A and the first common lead electrode 91B, the end portions being opposite to end portions connected to the first piezoelectric element 301. The flexible substrate 110 is electrically connected to a controller 4 and exchanges a signal that drives the first piezoelectric element 301, detection signals corresponding to residual vibrations generated in the second piezoelectric element 302, and the like with the controller 4 via a control circuit 111. That is, the control circuit 111 includes a plurality of switching elements that select whether or not to supply a drive signal for driving each of the first piezoelectric elements 301 to each of the first piezoelectric elements 301. That is, the flexible substrate 110 in the present embodiment is a chip on film (COF). Note that the flexible substrate 110 is not necessarily provided with the control circuit 111. That is, the flexible substrate 110 may be a flexible flat cable (FFC), flexible printed circuits (FPCs), or the like.

The third diaphragm 53 covers the opening corresponding to the absorption chamber 14 among the openings of the pressure chamber substrate 10 facing the -Z direction. The third diaphragm 53 is formed to be continuous with the first diaphragm 51 as described above. That is, the third diaphragm 53 includes the elastic film 50a and the insulating film 50b. The third diaphragm 53 is deformed by the pressure of the ink in the absorption chamber 14 and absorbs the pressure fluctuation of the ink in the absorption chamber 14.

In addition, the third piezoelectric element 303 is stacked on a surface of the third diaphragm 53 facing the -Z direction. The third piezoelectric element 303 is disposed at a position overlapping the absorption chamber 14 when viewed in the Z-axis direction. Similarly to the first piezoelectric element 301, the third piezoelectric element 303 includes a third lower electrode 63, a third piezoelectric layer 73, and a third upper electrode 83 which are sequentially stacked on the third diaphragm 53. The third lower electrode 63, the third piezoelectric layer 73, and the third upper electrode 83 are formed of the same materials as the first lower electrode 61, the first piezoelectric layer 71, and the first upper electrode 81 of the first piezoelectric element 301. The third piezoelectric element 303 is different from the first piezoelectric element 301 in that the third lower electrode 63 is provided continuously in the X-axis direction. As a matter of course, the third lower electrode 63 may be provided to be divided into a plurality with respect to one absorption chamber 14. The third piezoelectric element 303 is not necessarily required, and the third piezoelectric element 303 need not be provided.

The second diaphragm 52 covers the openings corresponding to the detection chambers 15 among the openings of the pressure chamber substrate 10 facing the -Z direction. The second diaphragm 52 is formed to be continuous with the first diaphragm 51. That is, the second diaphragm 52 includes the elastic film 50a and the insulating film 50b. As a matter of course, each layer of the second diaphragm 52 may be formed simultaneously with those of the first diaphragm 51 or may be formed individually. The second diaphragm 52 is deformable in accordance with the pressure fluctuation of the ink in the detection chambers 15. Each of a plurality of second diaphragms 52 individually deforms in correspondence with each of the plurality of detection chambers 15.

In addition, the second piezoelectric element 302 is stacked on the surface of the second diaphragm 52 facing the -Z direction. The second piezoelectric element 302 is disposed at a position overlapping the detection chambers 15 when viewed in the Z-axis direction. Similarly to the first piezoelectric element 301, the second piezoelectric element 302 includes a second lower electrode 62, a second piezoelectric layer 72, and a second upper electrode 82 which are sequentially stacked on the second diaphragm 52. A portion in which piezoelectric strain occurs in the second piezoelectric layer 72 when a voltage is applied between the second lower electrode 62 and the second upper electrode 82 is referred to as a second active portion 312. In contrast, a portion in which piezoelectric strain does not occur in the second piezoelectric layer 72 is referred to as a non-active portion. That is, the second active portion 312 refers to a portion where the second piezoelectric layer 72 is interposed between the second lower electrode 62 and the second upper electrode 82. In other words, the second active portion 312 refers to a portion where three of the second piezoelectric layer 72, the second lower electrode 62, and the second upper electrode 82 overlap in the Z-axis direction. In the present embodiment, the second active portion 312 is formed for each detection chamber 15. That is, a plurality of second active portions 312 are formed in the second piezoelectric element 302. The plurality of second active portions 312 serve as detection elements that detect pressure fluctuation in the detection chambers 15. In general, one of the electrodes of the second active portions 312 is configured as an individual electrode which is independent for each second active portion 312, and the other electrode is configured as a common electrode which is common to the plurality of second active portions 312. In the present embodiment, the second lower electrode 62 is configured as the individual electrode, and the second upper electrode 82 is configured as the common electrode. In the second piezoelectric element 302, a portion facing the detection chambers 15 in the Z-axis direction is referred to as a flexible portion, and an outer portion not facing the detection chambers 15 in the Z-axis direction is referred to as a non-flexible portion.

Here, the second lower electrode 62 is divided for each detection chamber 15 to be configured as individual electrodes which are independent for each second active portion 312. The second lower electrode 62 is formed to have a width narrower than the width of the detection chamber 15 in the X-axis direction. That is, in the X-axis direction, the end portions of the second lower electrode 62 are located inside the region opposed to the detection chamber 15. In addition, an end portion of the second lower electrode 62 in the +Y direction is disposed outside the detection chamber 15. The end portion of the second lower electrode 62 in the +Y direction, which is disposed outside the detection chamber 15, is not covered with the second piezoelectric layer 72, and is connected to a second individual lead electrode 92A which is a lead-out wiring.

The second piezoelectric layer 72 is provided continuously in the X-axis direction so as to have a predetermined width in the Y-axis direction. The second piezoelectric layer 72 has a second recessed portion 72a corresponding to each partition wall 11. The width of the respective second recessed portions 72a in the X-axis direction is equal to or wider than the width of the respective partition walls 11. In the present embodiment, the width of the second recessed portion 72a in the X-axis direction is wider than the width of the partition wall 11. Accordingly, since the rigidity of portions corresponding to both end portions of the detection chamber 15 of the diaphragm 50 in the X-axis direction, that is, so-called arm portions of the diaphragm 50 is reduced, it is possible to improve the displacement efficiency of the second piezoelectric element 302. Similarly to the first recessed portion 71a, the second recessed portion 72a may be provided to pass through the second piezoelectric layer 72 in the Z-axis direction, which is the thickness direction, or may be provided to the middle of the thickness of the second piezoelectric layer 72 without passing through the second piezoelectric layer 72.

The second upper electrode 82 is continuously provided over the surface of the second piezoelectric layer 72 facing the -Z direction and is configured as a common electrode common to the plurality of second active portions 312. The second upper electrode 82 is provided continuously over the X-axis direction so as to have a predetermined width in the Y-axis direction. The second upper electrode 82 is also provided on the inner surfaces of the second recessed portions 72a, that is, on the side surfaces of the second recessed portions 72a of the second piezoelectric layers 72 and on the diaphragm 50 which is the bottom surfaces of the second recessed portions 72a. As a matter of course, the second upper electrode 82 may be provided only on a part of the inner surfaces of the second recessed portions 72a and need not be provided over the entire surfaces of the second recessed portions 72a.

The width of each of the second piezoelectric layer 72 and the second upper electrode 82 in the X-axis direction may be the same as or different from the width of each of the first piezoelectric layer 71 and the first upper electrode 81 in the X-axis direction, respectively.

In the second piezoelectric element 302 as described above, both end portions of the second active portion 312 in the X-axis direction are defined by both end portions of the second lower electrode 62 in the X-axis direction. In addition, the end portion of the second active portion 312 in the -Y direction is defined by the end portion of the second lower electrode 62 in the -Y direction, and the end portion of the second active portion 312 in the +Y direction is defined by the end portion of the second upper electrode 82 in the +Y direction. The second lower electrode 62 is disposed at a position overlapping the center of the detection chamber 15 in the X-axis direction. That is, the second active portion 312 is disposed at a position overlapping the center of the detection chamber 15 in the X-axis direction. Similarly, the second active portion 312 is disposed at a position overlapping the center of the detection chamber 15 in the Y-axis direction. The center of the detection chamber 15 in the X-axis direction refers to an intersection of diagonal lines of the detection chamber 15 in a plan view in which the opening of the detection chamber 15 in the -Z direction is viewed in the +Z direction.

The second individual lead electrodes 92A serving as lead-out wirings are pulled out from the second lower electrodes 62, respectively. A second common lead electrode 92B serving as a lead-out wiring is led out from the second upper electrodes 82. The second individual lead electrodes 92A and the second common lead electrode 92B are formed of the same layer but are formed so as to be electrically discontinuous. In the present embodiment, the first individual lead electrodes 91A, the first common lead electrode 91B, the second individual lead electrodes 92A, and the second common lead electrode 92B are formed in the same layer. Accordingly, it is possible to simultaneously form the first individual lead electrodes 91A, the first common lead electrode 91B, the second individual lead electrodes 92A, and the second common lead electrode 92B, and it is possible to reduce the cost.

In addition, the second common lead electrode 92B includes second extension portions 94 respectively provided on the respective wall surfaces on both sides of the detection chambers 15 in the Y-axis direction to extend over the boundary portion between the flexible portion and the non-flexible portion. The second extension portions 94 are partially provided on the second upper electrode 82 and are respectively provided at both ends of the second upper electrode 82 and the second piezoelectric layer 72 in the Y-axis direction. Each of the second extension portions 94 is provided continuously over the X-axis direction of the plurality of second active portions 312, and an end portion of each of the second extension portions 94 in the X-axis direction is continuous with the second common lead electrode 92B. That is, the second common lead electrode 92B including the second extension portions 94 is continuously disposed so as to surround the plurality of second active portions 312 in a plan view from the +Z direction. That is, the second extension portions 94 refer to two portions of the second common lead electrode 92B provided along the X-axis direction.

By providing the second extension portions 94 in this way, it is possible to suppress a voltage drop in the X-axis direction of the second upper electrode 82, and it is possible to improve the detection efficiency of the pressure fluctuation of the ink in the detection chambers 15 in the second active portions 312. In addition, by providing each of the second extension portions 94 at a position overlapping the boundary between the flexible portion and the non-flexible portion when viewed in the +Z direction, it is possible to improve the rigidity of the boundary between the flexible portion and the non-flexible portion, and to suppress the destruction of the second piezoelectric layer 72 in the stress concentration of the boundary between the flexible portion and the non-flexible portion. In addition, in the direction along the Y axis, by respectively providing the second extension portions 94 on both end portions where the deformation amount of the second active portions 312 is relatively small and not providing the second extension portions 94 in the center portion where the deformation amount is relatively large, it is possible to suppress the second extension portions 94 from inhibiting the deformation of the second active portions 312 and to suppress a significant decrease in the deformation amount of the second piezoelectric element 302.

The flexible substrate 110 is connected to end portions of each of the second individual lead electrodes 92A and the second common lead electrode 92B, the end portions being opposite to end portions connected to the second piezoelectric element 302.

Here, when the pressure fluctuation is generated in the ink in the pressure chamber 12 by the first piezoelectric element 301 and the ink droplets are ejected from the nozzle 21, the pressure fluctuation of the pressure chamber 12 remains for a predetermined period after the ink droplets are ejected. This is called a residual vibration. Since the pressure fluctuation of the ink in the pressure chamber 12 is also propagated to the ink in the detection chamber 15 via the collection path 124, the second piezoelectric element 302 detects the residual vibration of the detection chamber 15. That is, the second piezoelectric element 302 detects the residual vibration as a voltage signal by the electromotive voltage generated when the residual vibration of the ink in the detection chamber 15 fluctuates. Then, the control circuit 111 extracts the state of the residual vibration, for example, information such as the cycle and amplitude of the residual vibration from the voltage signal generated in the second piezoelectric element 302, and outputs the information to the controller 4. The controller 4 detects an ejection failure of ink droplets from information such as the cycle and amplitude of the residual vibration.

Here, as shown in FIGS. 4 -6, in the plan view as viewed in the +Z direction, a width W1 of the second active portion 312 in the X-axis direction is larger than a width W3 of the first active portion 311 in the X-axis direction. In the present embodiment, the end portions of the second active portion 312 in the X-axis direction are defined by the second lower electrode 62, and the end portions of the first active portion 311 in the X-axis direction are defined by the first lower electrode 61. Therefore, in the plan view as viewed in the +Z direction, the width W1 of the second active portion 312 in the X-axis direction is the width W1 of the second lower electrode 62 in the X-axis direction, and the width W3 of the first active portion 311 in the X-axis direction is the width W3 of the first lower electrode 61 in the X-axis direction. That is, the width W1 of the second lower electrode 62 in the X-axis direction is larger than the width W3 of the first lower electrode 61 in the X-axis direction.

As shown in FIGS. 4, 7, and 8, in the plan view as viewed in the +Z direction, a length L1 of the second active portion 312 in the Y-axis direction is smaller than a length L3 of the first active portion 311 in the Y-axis direction.

In this way, by increasing the amount of strain of the second active portion 312 by making the width W1 of the second active portion 312 in the X-axis direction relatively large, it is possible to increase the voltage output by the second active portion 312 due to the pressure fluctuation in the detection chamber 15, and to improve the detection accuracy of the pressure fluctuation in the detection chamber 15. Furthermore, by making the width W3 of the respective first active portions 311 in the X-axis direction relatively small, it is possible to suppress crosstalk between the first active portions 311 adjacent to each other in the X-axis direction. To be specific, when the width W3 of the respective first active portions 311 in the X-axis direction is made smaller, a distance d1 between the first active portions 311 adjacent to each other in the X-axis direction is increased. Therefore, in the two first active portions 311 adjacent to each other, since the vibration of one first active portion 311 is attenuated until the vibration is transmitted to the other first active portion 311, it is possible to suppress so-called crosstalk in which the vibration of one first active portion 311 affects the other first active portion 311. Here, the second active portion 312 is strained mainly by the residual vibration generated in the detection chamber 15 due to the driving of the first active portion 311. Therefore, since the amount of strain of the second active portions 312 is smaller than that of the first active portions 311, crosstalk is less likely to occur between two second active portions 312 adjacent to each other in the X-axis direction, and even when a distance d2 between the second active portions 312 adjacent to each other in the X-axis direction is small, a problem due to crosstalk is less likely to occur. Therefore, by making the width W1 of the respective second active portions 312 in the X-axis direction larger than the width W3 of the respective first active portions 311 in the X-axis direction, it is possible to improve the detection accuracy of the residual vibration by the second active portions 312 and to suppress the crosstalk of the first active portions 311.

The width W1 of the respective second active portions 312 in the X-axis direction, the width W2 of the respective detection chambers 15 in the X-axis direction, the width W3 of the respective first active portions 311 in the X-axis direction, and the width W4 of the respective pressure chambers 12 in the X-axis direction satisfy the relationship of W1/W2 > W3/W4. In the present embodiment, since the width W2 of the detection chamber 15 is the same as the width W4 of the pressure chamber 12, the relationship of W1/W2 > W3/W4 is satisfied by making the width W1 of the second active portion 312 larger than the width W3 of the first active portion 311. In this way, by defining the relationship among the width W1 of the second active portion 312, the width W2 of the detection chamber 15, the width W3 of the first active portion 311, and the width W4 of the pressure chamber 12, the second active portion 312 can be provided to have a width as wide as possible with respect to the detection chamber 15 having the width W2 limited in the X-axis direction. Therefore, the amount of strain of the second active portion 312 can be increased to improve the detection accuracy of the residual vibration by the second active portion 312.

In the plan view in the +Z direction, an area S1 of the respective second active portions 312, an area S2 of the respective detection chambers 15, an area S3 of the respective first active portions 311, and an area S4 of the respective pressure chambers 12 satisfy the relationship of S1/S2 > S3/S4. In this way, by defining the relationship among the area S1 of the second active portion 312, the area S2 of the detection chamber 15, the area S3 of the first active portion 311, and the area S4 of the pressure chamber 12, the second active portion 312 can be provided to have an area as large as possible with respect to the detection chamber 15 having a limited area. Therefore, the amount of strain of the second active portion 312 can be increased to improve the detection accuracy of the residual vibration by the second active portion 312. In addition, since the area S3 of the respective first active portions 311 can be made relatively small with respect to the respective pressure chambers 12, the amount of deformation of the first active portions 311 can be reduced, and in the two first active portions 311 adjacent to each other, so-called crosstalk in which the vibration of one first active portion 311 affects the other first active portion 311 can be suppressed.

As shown in FIG. 4, it is preferable that the distance d1 in the X-axis direction between the two first active portions 311 adjacent to each other in the X-axis direction be larger than the width W3 of the first active portion 311 in the X-axis direction. In this way, by making the distance d1 between the two first active portions 311 adjacent to each other in the X-axis direction larger than the width W3 of the first active portion 311 in the X-axis direction, it is possible to reduce crosstalk that occurs between the first active portions 311 adjacent to each other in the X-axis direction. It is more preferable that the distance d1 between the two first active portions 311 adjacent to each other in the X-axis direction be larger than the width W1 of the second active portion 312 in the X-axis direction. This also makes the distance d1 between the two first active portions 311 adjacent to each other in the X-axis direction larger to make it possible to reduce crosstalk that occurs between the first active portions 311 adjacent to each other in the X-axis direction.

As shown in FIG. 4, it is preferable that the width W1 of the respective second active portions 312 in the X-axis direction be larger than the distance d2 in the X-axis direction between two second active portions 312 adjacent to each other in the X-axis direction. In this way, by making the width W1 of the respective second active portions 312 in the X-axis direction larger than the distance d2 between the two second active portions 312 in the X-axis direction, the width W1 of the respective second active portions 312 can be made relatively large, and the detection accuracy of the residual vibration by the second active portions 312 can be improved. The distance d1 and the distance d2 are the minimum dimensions of the intervals along the X-axis direction in a plan view in the +Z direction.

In the present embodiment, as described above, the length L2 of the detection chamber 15 in the Y-axis direction is smaller than the length L4 of the pressure chamber 12 in the Y-axis direction. In the present embodiment, since the width W2 of the detection chamber 15 in the X-axis direction is smaller than the width W4 of the pressure chamber 12 in the X-axis direction, the area of the detection chamber 15 is smaller than the area of the pressure chamber 12 in a plan view as viewed in the +Z direction. In the present embodiment, since the pressure chambers 12 and the detection chambers 15 are provided to pass through the pressure chamber substrate 10 in the Z-axis direction, the pressure chambers 12 and the detection chambers 15 have the same height in the Z-axis direction. Therefore, the volume of the respective detection chambers 15 is smaller than the volume of the respective pressure chambers 12. Since the compliance of the individual flow paths as a whole can be reduced by reducing the size of the detection chamber 15 and reducing the compliance of the detection chamber 15 in this way, the first active portion 311 can be driven at a high frequency. When the compliance of the detection chamber 15 is reduced, the second diaphragm 52 corresponding to the detection chamber 15 is less likely to be strained. However, by increasing the amount of strain of the second active portion 312 by making the width W1 of the second active portion 312 in the X-axis direction larger than the width W3 of the first active portion 311, the detection accuracy of the residual vibration in the detection chamber 15 by the second active portion 312 can be improved. That is, if the second diaphragm 52 corresponding to the detection chamber 15 is not easily strained, the amount of deformation of the second active portion 312 decreases, and the voltage output from the second active portion 312 decreases. However, by making the width W1 of the second active portion 312 larger, the second active portion 312 can be strained relatively greatly and a large voltage can be output, and thus the detection accuracy can be improved. Incidentally, instead of making the length L1 of the detection chamber 15 in the Y-axis direction smaller than the length L4 of the pressure chamber 12 in the Y-axis direction, for example, also in at least one of a case where the second diaphragm 52 corresponding to the detection chamber 15 is thicker, a case having a harder material, and a case having a higher Young's modulus, than the first diaphragm 51 corresponding to the pressure chamber 12, the same effect can be obtained.

In addition, the pressure chambers 12 and the detection chambers 15 are provided in the same pressure chamber substrate 10, and the pressure chamber substrate 10 includes the partition wall 17 provided between the pressure chambers 12 and the detection chambers 15 and defining side surfaces of the pressure chambers 12 and the detection chambers 15 in the Y-axis direction. In this way, by partitioning the detection chamber 15 and the pressure chamber 12 by the partition wall 17, the pressure generated in the pressure chamber 12 by the first active portion 311 is unlikely to be absorbed by the deformation of the second diaphragm 52 corresponding to the second active portion 312, and it is possible to perform high-frequency ejection of ink by driving the first active portion 311 at a high frequency. Incidentally, if the pressure chamber 12 and the detection chamber 15 are not partitioned by the partition wall 17, that is, if the first active portion 311 and the second active portion 312 are provided corresponding to a common space in which the pressure chamber 12 and the detection chamber 15 are continuous, the pressure generated in the pressure chamber 12 by the first active portion 311 is easily absorbed by the deformation of the second diaphragm 52 corresponding to the second active portion 312, and the first active portion 311 cannot be driven at a high frequency.

The protective substrate 30 having substantially the same size as the pressure chamber substrate 10 is joined to the surface of the pressure chamber substrate 10 facing the -Z direction. The protective substrate 30 includes accommodation portions 31A to 31C which are spaces for protecting the first piezoelectric element 301, the second piezoelectric element 302, and the third piezoelectric element 303, respectively. The accommodation portions 31A to 31C each have a recessed shape which is open on a surface of the protective substrate 30 facing the +Z direction. The plurality of first active portions 311 are accommodated in the accommodation portion 31A. The plurality of second active portions 312 are accommodated in the accommodation portion 31B. The single third piezoelectric element 303 is accommodated in the accommodation portion 31C. In addition, the protective substrate 30 has an opening portion 32 passing in the Z-axis direction between two accommodation portions 31A and 31B disposed side by side in the Y-axis direction. The respective end portions of the first individual lead electrodes 91A and the first common lead electrode 91B which are led out from the respective electrodes of the first piezoelectric element 301, and the respective end portions of the second individual lead electrodes 92A and the second common lead electrode 92B which are led out from the respective electrodes of the second piezoelectric element 302 are extended so as to be exposed in the opening portion 32. The first individual lead electrodes 91A, the first common lead electrode 91B, the second individual lead electrodes 92A, and the second common lead electrode 92B are electrically connected to the flexible substrate 110 in the opening portion 32. Such an opening portion 32 is disposed at a position overlapping the collection paths 124 when viewed in the Z-axis direction. That is, the flexible substrate 110 is joined to each of the lead electrodes 91A, 91B, 92A, 92B and the like led out from the first piezoelectric element 301 and the second piezoelectric element 302 on the diaphragm 50 at a position which is in the -Z direction of the diaphragm 50 and overlaps the collection paths 124 when viewed in the -Z direction. That is, the flexible substrate 110 is connected onto the diaphragm 50 between the pressure chambers 12 and the detection chambers 15 in the Y-axis direction. That is, the flexible substrate 110 is connected onto the diaphragm 50 at a position overlapping a portion of the pressure chamber substrate 10 where the flow paths are not provided when viewed in the -Z direction. Here, since the diaphragm 50 applies pressure to the pressure chambers 12 and is deformed by the pressure fluctuation in the detection chambers 15, the diaphragm 50 is relatively thin and is easily deformed. For this reason, if the collection paths are provided in, for example, the pressure chamber substrate 10, the diaphragm 50 on the collection paths would be thin, and the flexible substrate 110 would be connected onto the diaphragm 50 on the collection paths, so that the diaphragm 50 would be easily broken by the stress when the flexible substrate 110 is connected. In the present embodiment, the collection paths 124 are provided in the communication plate 120, and the flexible substrate 110 is connected onto the diaphragm 50 at a position overlapping a portion where the flow paths of the pressure chamber substrate 10 are not provided when viewed in the -Z direction. For this reason, the region of the diaphragm 50 to which the flexible substrate 110 is connected is supported by the pressure chamber substrate 10. Therefore, it is possible to suppress the occurrence of a crack in the diaphragm 50 due to the stress when the flexible substrate 110 is connected onto the diaphragm 50.

As such a protective substrate 30, a silicon substrate or an SOI substrate is preferably used. The material of the protective substrate 30 is not limited to this, and a glass substrate, any kind of ceramic substrates, a metal substrate such as a stainless-steel substrate, or the like may be used.

In addition, the protective substrate 30 includes a flow path 33A which constitutes a portion of the supply-side common liquid chamber 100A, and a flow path 33B which constitutes a portion of the discharge-side common liquid chamber 100B. The flow paths 33A and 33B are provided to pass through the protective substrate 30 in the Z-axis direction. The flow path 33A is located in the +Y direction of the accommodation portion 31C, and the flow path 33B is located in the -Y direction of the accommodation portion 31B.

The case 40 is located in the -Z direction of the protective substrate 30. The case 40 includes a flow path 41A constituting a part of the supply-side common liquid chamber 100A, and a flow path 41B constituting a part of the discharge-side common liquid chamber 100B. The flow path 41A is disposed at a position overlapping the flow path 33A of the protective substrate 30 when viewed in the Z-axis direction and communicates with the flow path 33A. The flow path 41B is disposed at a position overlapping the flow path 33B of the protective substrate 30 when viewed in the Z-axis direction and communicates with the flow path 33B. The flow paths 41A and 41B each have a recessed shape which is open on a surface of the case 40 facing the +Z direction. In addition, the case 40 includes a supply port 42 for supplying the ink to the flow path 41A and a discharge port 43 for discharging the ink in the flow path 41B to the outside. As such a case 40, metal or resin is used, for example.

The supply-side common liquid chamber 100A of the present embodiment is constituted by the flow path 41A provided in the case 40, the flow path 33A provided in the protective substrate 30, the flow path 16A provided in the pressure chamber substrate 10, and the flow path 121A provided in the communication plate 120. The discharge-side common liquid chamber 100B is constituted by the flow path 41B provided in the case 40, the flow path 33B provided in the protective substrate 30, the flow path 16B provided in the pressure chamber substrate 10, and the flow path 121B provided in the communication plate 120. The ink from a liquid storage portion (not shown) is supplied to the supply-side common liquid chamber 100A via the supply port 42. The ink in the supply-side common liquid chamber 100A flows to the discharge-side common liquid chamber 100B via the absorption chamber 14, the ink supply paths 13, the pressure chambers 12, the collection paths 124, and the detection chambers 15. Then, the ink in the discharge-side common liquid chamber 100B is discharged to the outside of the liquid ejecting head H from the discharge port 43.

The case 40 also has a through hole 44 communicating with the opening portion 32 of the protective substrate 30. The through hole 44 is provided to pass through the case 40 in the Z-axis direction. Then, the flexible substrate 110 connected to the first piezoelectric element 301 and the second piezoelectric element 302 on the diaphragm 50 of the pressure chamber substrate 10 is led out toward a surface of the case 40 facing the -Z direction through the opening portion 32 of the protective substrate 30 and the through hole 44 of the case 40.

In addition, a supply-side compliance substrate 130A and a discharge-side compliance substrate 130B are provided on a surface facing the +Z direction on which the flow paths 121A and 121B of the communication plate 120 are open. In the present embodiment, the supply-side compliance substrate 130A and the discharge-side compliance substrate 130B have the same configuration. Therefore, the supply-side compliance substrate 130A will be described below, but the discharge-side compliance substrate 130B has the same configuration.

In the present embodiment, the compliance substrate 130A includes a sealing film 131 made of a flexible thin film and a fixing substrate 132 made of a hard material such as metal. A region of the fixing substrate 132 opposite to the common liquid chamber 100A is an opening portion 133 in which the fixing substrate 132 is completely removed in the thickness direction, and a surface of the common liquid chamber 100A in the +Z direction is a compliance portion 134 defined only by the sealing film 131. Since such a compliance portion 134 is deformed, it is possible to absorb the pressure fluctuation of the ink in the common liquid chamber 100A and to suppress the occurrence of the variation in the ejection characteristics such as the flying speed and the weight of the ink droplets ejected from the nozzles 21.

### Second Embodiment

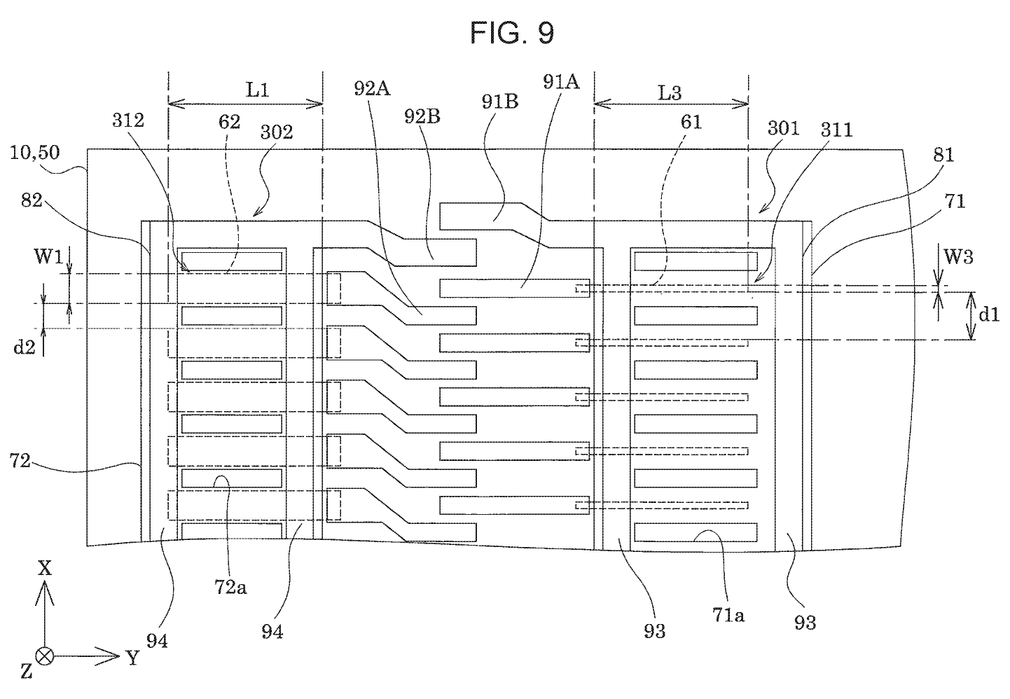

FIG. 9 is a plan view in which the first piezoelectric element 301, the second piezoelectric element 302, and the pressure chamber substrate 10 according to the second embodiment of the present disclosure are viewed in the +Z direction.

As shown in FIG. 9, the length L1 of the respective second active portions 312 of the second piezoelectric element 302 in the Y-axis direction is the same as the length L3 of the respective first active portions 311 of the first piezoelectric element 301 in the Y-axis direction.

Similarly to the first embodiment described above, the width W1 of the second active portion 312 in the X-axis direction is larger than the width W3 of the first active portion 311 in the X-axis direction.

Therefore, in a plan view in the +Z direction, the area of the second active portion 312, that is, the area S1 defined by the width W1 in the X-axis direction and the length L1 is larger than the area of the first active portion 311, that is, the area S3 defined by the width W3 in the X-axis direction and the length L3.

In this way, by making the area S1 of the respective second active portions 312 larger than the area S3 of the respective first active portions 311, the area S1 of the respective second active portions 312 can be made relatively large to increase the amount of strain, and the voltage output from the second active portions 312 can be made large to improve the detection accuracy of the residual vibration by the second active portions 312. In addition, by making the area S3 of the respective first active portions 311 smaller, the amount of deformation of the first active portions 311 can be reduced, and in the two first active portions 311 adjacent to each other, so-called crosstalk in which the vibration of one first active portion 311 affects the other first active portion 311 can be suppressed. Since the second active portion 312 is strained mainly by the pressure fluctuation in the detection chamber 15 generated by the driving of the first active portion 311, that is, by the residual vibration, the amount of strain of the second active portion 312 is smaller than that of the first active portion 311. Therefore, even when the area S1 of the respective second active portions 312 is made larger, crosstalk is unlikely to occur between two second active portions 312 adjacent to each other in the X-axis direction.

In addition, by making the area S1 of the respective second active portions 312 larger than the area S3 of the respective first active portions 311, as described above, the ratio of the area S1 of the respective second active portions 312 to the area S2 of the respective detection chambers 15 and the ratio of the area S3 of the respective first active portions 311 to the area S4 of the respective pressure chambers 12 easily satisfy the relationship of S1/S2 > S3/S4. As a result, the second active portion 312 can be provided to have an area as large as possible with respect to the detection chamber 15 having a limited area. Therefore, the amount of strain of the second active portion 312 can be increased to improve the detection accuracy of the residual vibration by the second active portion 312.

Also in the present embodiment, similarly to the first embodiment described above, the width W1 of the respective second active portions 312 is made larger than the width W3 of the respective first active portions 311 to make the area S1 larger than the area S2. Therefore, by making the width W3 of the respective first active portions 311 in the X-axis direction relatively small, it is possible to suppress crosstalk between the first active portions 311 adjacent to each other in the X-axis direction. That is, when the width W3 of the respective first active portions 311 in the X-axis direction is made smaller, the distance d1 between the first active portions 311 adjacent to each other in the X-axis direction is increased. Therefore, in the two first active portions 311 adjacent to each other, since the vibration of one first active portion 311 is attenuated until the vibration is transmitted to the other first active portion 311, it is possible to suppress so-called crosstalk in which the vibration of one first active portion 311 affects the other first active portion 311. Here, the second active portion 312 is strained mainly by the residual vibration generated in the detection chamber 15 due to the driving of the first active portion 311. Therefore, since the amount of strain of the second active portions 312 is smaller than that of the first active portions 311, crosstalk is less likely to occur between two second active portions 312 adjacent to each other in the X-axis direction, and even when a distance d2 between the second active portions 312 adjacent to each other in the X-axis direction is small, a problem due to crosstalk is less likely to occur. Therefore, by making the width W1 of the respective second active portions 312 in the X-axis direction larger than the width W3 of the respective first active portions 311 in the X-axis direction, it is possible to improve the detection accuracy of the residual vibration by the second active portions 312 and to suppress the crosstalk of the first active portions 311.

Also in the present embodiment, similarly to the first embodiment described above, the width W1 of the respective second active portions 312 in the X-axis direction, the width W2 of the respective detection chambers 15 in the X-axis direction, the width W3 of the respective first active portions 311 in the X-axis direction, and the width W4 of the respective pressure chambers 12 in the X-axis direction satisfy the relationship of W1/W2 > W3/W4. In the present embodiment, similarly to the first embodiment described above, the width W2 of the respective detection chambers 15 and the width W4 of the respective pressure chambers 12 are the same. Therefore, the relationship of W1/W2 > W3/W4 is satisfied by making the width W1 of the respective second active portions 312 larger than the width W3 of the respective first active portions 311. In this way, by defining the relationship among the width W1 of the second active portion 312, the width W2 of the detection chamber 15, the width W3 of the first active portion 311, and the width W4 of the pressure chamber 12, the second active portion 312 can be provided to have a width as wide as possible with respect to the detection chamber 15 having the width W2 limited in the X-axis direction. Therefore, the amount of strain of the second active portion 312 can be increased to improve the detection accuracy of the residual vibration by the second active portion 312.

Also in the present embodiment, similarly to the first embodiment described above, it is preferable that the distance d1 in the X-axis direction between the two first active portions 311 adjacent to each other in the X-axis direction be larger than the width W3 of the first active portion 311 in the X-axis direction. In this way, by making the distance d1 between the two first active portions 311 adjacent to each other in the X-axis direction larger than the width W3 of the first active portion 311 in the X-axis direction, it is possible to reduce crosstalk that occurs between the first active portions 311 adjacent to each other in the X-axis direction. It is more preferable that the distance d1 between the two first active portions 311 adjacent to each other in the X-axis direction be larger than the width W1 of the second active portion 312 in the X-axis direction. This also makes the distance d1 between the two first active portions 311 adjacent to each other in the X-axis direction larger to make it possible to reduce crosstalk that occurs between the first active portions 311 adjacent to each other in the X-axis direction.

Also in the present embodiment, similarly to the first embodiment described above, it is preferable that the width W1 of the second active portion 312 in the X-axis direction be larger than the distance d2 between the two second active portions 312 adjacent to each other in the X-axis direction. In this way, by making the width W1 of the respective second active portions 312 in the X-axis direction larger than the distance d2 between the two second active portions 312 in the X-axis direction, the width W1 of the respective second active portions 312 can be made relatively large, and the detection accuracy of the residual vibration by the second active portions 312 can be improved. The distance d1 and the distance d2 are the minimum dimensions of the intervals along the X-axis direction in a plan view in the +Z direction.

In the present embodiment, similarly to the first embodiment described above, the length L2 of the detection chamber 15 in the Y-axis direction is smaller than the length L4 of the pressure chamber 12 in the Y-axis direction. In the present embodiment, since the width W2 of the detection chamber 15 in the X-axis direction is smaller than the width W4 of the pressure chamber 12 in the X-axis direction, the area of the detection chamber 15 is smaller than the area of the pressure chamber 12 in a plan view as viewed in the +Z direction. In the present embodiment, since the pressure chambers 12 and the detection chambers 15 are provided to pass through the pressure chamber substrate 10 in the Z-axis direction, the pressure chambers 12 and the detection chambers 15 have the same height in the Z-axis direction. Therefore, the volume of the respective detection chambers 15 is smaller than the volume of the respective pressure chambers 12. Since the compliance of the individual flow paths as a whole can be reduced by reducing the size of the detection chamber 15 and reducing the compliance of the detection chamber 15 in this way, the first active portion 311 can be driven at a high frequency. When the compliance of the detection chamber 15 is reduced, the second diaphragm 52 corresponding to the detection chamber 15 is less likely to be strained. However, by increasing the amount of strain of the second active portion 312 by making the width W1 of the second active portion 312 in the X-axis direction larger than the width W3 of the first active portion 311, the detection accuracy of the residual vibration in the detection chamber 15 by the second active portion 312 can be improved. That is, if the second diaphragm 52 corresponding to the detection chamber 15 is not easily strained, the amount of deformation of the second active portion 312 decreases, and the voltage output from the second active portion 312 decreases. However, by making the width W1 of the second active portion 312 larger, the second active portion 312 can be strained relatively greatly and a large voltage can be output, and thus the detection accuracy can be improved. Incidentally, instead of making the length L1 of the detection chamber 15 in the Y-axis direction smaller than the length L4 of the pressure chamber 12 in the Y-axis direction, for example, also in at least one of a case where the second diaphragm 52 corresponding to the detection chamber 15 is thicker, a case having a harder material, and a case having a higher Young's modulus, than the first diaphragm 51 corresponding to the pressure chamber 12, the same effect can be obtained.

Also in the present embodiment, similarly to the first embodiment described above, the pressure chambers 12 and the detection chambers 15 are provided in the same pressure chamber substrate 10, and the pressure chamber substrate 10 includes the partition wall 17 which is provided between the pressure chambers 12 and the detection chambers 15 and defines side surfaces of the pressure chambers 12 and the detection chambers 15 in the Y-axis direction. In this way, by partitioning the detection chamber 15 and the pressure chamber 12 by the partition wall 17 (see FIG. 3), the pressure generated in the pressure chamber 12 by the first active portion 311 is unlikely to be absorbed by the deformation of the second diaphragm 52 corresponding to the second active portion 312, and it is possible to perform high-frequency ejection of ink by driving the first active portion 311 at a high frequency. Incidentally, if the pressure chamber 12 and the detection chamber 15 are not partitioned by the partition wall 17, that is, if the first active portion 311 and the second active portion 312 are provided corresponding to a common space in which the pressure chamber 12 and the detection chamber 15 are continuous, the pressure generated in the pressure chamber 12 by the first active portion 311 is easily absorbed by the deformation of the second diaphragm 52 corresponding to the second active portion 312, and the first active portion 311 cannot be driven at a high frequency.

As in the first embodiment described above, even when the length L1 of the second active portion 312 in the Y-axis direction is shorter than the length L3 of the first active portion 311 in the Y-axis direction, if the width W1 of the second active portion 312 in the X-axis direction is sufficiently larger than the width W3 of the first active portion 311 in the X-axis direction, the area of the second active portion 312 can be larger than the area of the first active portion 311 in the plan view viewed as viewed in the +Z direction.

In the present embodiment, the area S1 of the respective second active portions 312 is made larger than the area S3 of the respective first active portions 311 in the plan view in the +Z direction by making the length L2 of the respective second active portions 312 the same as the length L1 of the respective first active portions 311 to make the width W1 of the respective second active portions 312 larger than the width W3 of the respective first active portions 311, but the present disclosure is not particularly limited thereto. For example, the area S1 of the second active portion 312 may be made larger than the area S3 of the first active portion 311 by making the width W1 of the second active portion 312 the same as the width W3 of the first active portion 311 to make the length L1 of the second active portion 312 longer than the length L3 of the first active portion 311. Alternatively, the area S1 of the second active portion 312 may be made larger than the area S3 of the first active portion 311 by making one of the width W1 and the length L1 of the second active portion 312 smaller than the width W3 and the length L3 of the first active portion 311, respectively, and making the other one of the width W1 and the length L1 of the second active portion 312 larger than the width W3 and the length L3 of the first active portion 311.

### Other Embodiments

Although each embodiment of the present disclosure has been described above, the basic configuration of the present disclosure is not limited to the above-described embodiments.

For example, in each of the embodiments described above, in the first piezoelectric element 301, the first lower electrodes 61 are configured as the individual electrodes of the first active portions 311, respectively, and the first upper electrodes 81 are configured as the common electrode of the plurality of first active portions 311, but the present disclosure is not particularly limited thereto, and the first lower electrodes 61 may be configured as the common electrode of the plurality of first active portions 311, and the first upper electrodes 81 may be configured as the individual electrodes of the first active portions 311, respectively. Similarly, in the second piezoelectric element 302, the second lower electrodes 62 may be configured as the common electrode of the plurality of second active portions 312, and the second upper electrodes 82 may be configured as individual electrodes of the second active portions 312, respectively. In this way, in the case where the first upper electrodes 81 and the second upper electrodes 82 are individual electrodes, the width of the second active portion 312 in the X-axis direction may be made larger than the width of the first active portion 311 by changing the widths of the first upper electrode 81 and the second upper electrode 82 in the X-axis direction. In addition, the area of the second active portion 312 may be made larger than the area of the first active portion 311 by changing the areas of the first upper electrode 81 and the second upper electrode 82 in the plan view in the +Z direction.

In addition, in each of the embodiments described above, the collection paths 124 are each formed of a recessed portion provided in the communication plate 120, but is not particularly limited thereto, and the collection paths 124 may be provided to pass through the communication plate 120 in the Z-axis direction, may be provided in the pressure chamber substrate 10, or may be provided in both the pressure chambers 12 and the communication plate 120.

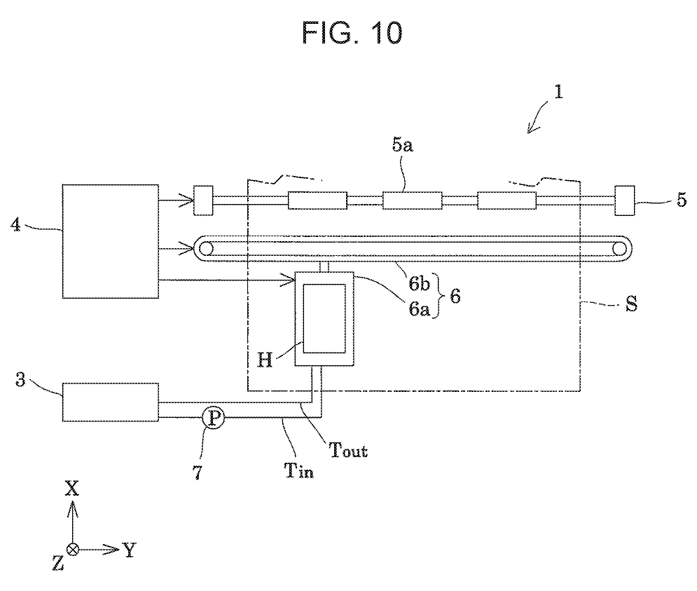

In addition, the liquid ejecting head H of each embodiment described above is mounted on a liquid ejecting apparatus 1. FIG. 10 is a view showing a schematic configuration of the liquid ejecting apparatus 1 according to an embodiment of the present disclosure.

As shown, the liquid ejecting apparatus 1 is a so-called serial printer which includes the liquid ejecting head H and performs printing by ejecting (also referred to as jetting) liquid in the +Z direction from the liquid ejecting head H toward a medium S while transporting the medium S in the X-axis direction and reciprocating the liquid ejecting head H in the Y-axis direction. For the medium S, any material such as recording paper, resin film, or cloth can be used. In addition, the direction in which the liquid ejecting head H reciprocates is not limited to the Y-axis direction and may be a direction inclined with respect to both the X-axis direction and the Y-axis direction.

The liquid ejecting apparatus 1 includes the liquid ejecting head H, a liquid storage portion 3, a controller 4, a transport mechanism 5 that sends out the medium S, and a movement mechanism 6.

The liquid ejecting head H jets liquid supplied from the liquid storage portion 3 as liquid droplets in the +Z direction.

The liquid storage portion 3 stores liquid to be jetted from the liquid ejecting head H. Examples of the liquid storage portion 3 include, for example, a cartridge attachable to and detachable from the liquid ejecting apparatus 1, a bag-shaped ink pack made of a flexible film, and an ink tank that can be refilled with ink.

A supply tube Tin and a discharge tube Tout are connected to the liquid storage portion 3.

The supply tube Tin is a tube that supplies, to the liquid ejecting head H, the ink of the liquid storage portion 3 caused to have a predetermined pressure by a pump 7. The discharge tube Tout is a tube that collects the ink collected from the liquid ejecting head H to the liquid storage portion 3.

Although not particularly shown, the liquid storage portion 3 may be divided into a main tank and a sub-tank. The sub-tank may be connected to the liquid ejecting head H and may be configured to be refilled with the liquid consumed by jetting the liquid droplets from the liquid ejecting head H, from the main tank.

The controller 4 includes, for example, a control device such as a central processing unit (CPU) or a field programmable gate array (FPGA), and a storage device such as a semiconductor memory. The controller 4 also includes a power supply device that supplies power supplied from an external power supply such as a commercial power supply to each element of the liquid ejecting apparatus 1. The controller 4 is electrically connected to the liquid ejecting head H via the flexible substrate 110 described above. The controller 4 comprehensively controls each element of the liquid ejecting apparatus 1 by the control device executing a program stored in the storage device.

The transport mechanism 5 transports the medium S in the X-axis direction, and has, for example, a transport roller 5a that rotates by a transport motor controlled and driven by the controller 4.

The movement mechanism 6 is a mechanism for reciprocating the liquid ejecting head H in the Y-axis direction and includes a holder 6a that holds the liquid ejecting head H, and a transport belt 6b which is an endless belt installed along the Y-axis direction. The controller 4 rotates the transport belt 6b by controlling the driving of the transport motor (not shown) to reciprocate the liquid ejecting head H in the Y-axis direction together with the holder 6a fixed to the transport belt 6b. The liquid storage portion 3 can also be mounted on the holder 6a together with the liquid ejecting head H. The holder 6a holds one liquid ejecting head H, but the holder 6a may hold two or more liquid ejecting heads H.

The liquid ejecting head H, under the control of the controller 4, performs an ejecting operation of ejecting the ink supplied from the liquid storage portion 3 in the form of ink droplets from each of the plurality of nozzles 21 in the +Z direction. The controller 4 functions as an ejection controller that controls the ejection of the ink by the liquid ejecting head H. The ejecting operation performed by the liquid ejecting head H is performed in parallel with the transportation of the medium S in the X-axis direction that is performed by the transport mechanism 5 and the reciprocation of the liquid ejecting head H in the Y-axis direction that is caused by the movement mechanism 6, so that so-called printing, in which ink is applied to the medium S, is performed.

Note that, in the example shown in FIG. 10, the liquid ejecting apparatus 1 in which the liquid ejecting head H is mounted on the holder 6a and moves in the main scanning direction is exemplified, but the configuration is not particularly limited thereto, and, for example, the present disclosure can also be applied even to a so-called line printer in which the liquid ejecting head H is fixed and only the medium S is moved in a sub-scanning direction to perform printing.

The present disclosure is widely intended for liquid ejecting heads and liquid ejecting apparatuses in general, and can be applied to liquid ejecting heads and liquid ejecting apparatuses which jet liquid other than ink. Examples of other liquid ejection heads include, for example, various recording heads used in image recording apparatuses such as printers, color material ejection heads used in the manufacture of color filters for liquid crystal displays and the like, electrode material ejection heads used in the formation of electrodes for organic EL displays, field emission displays (FEDs) and the like, and bio-organic substance ejection heads used in the manufacture of biochips, and the like, and the present disclosure can also be applied to liquid ejection apparatuses including such liquid ejection heads.

### ADDITIONAL NOTES

From the forms described above, for example, the following configurations can be understood.

A liquid ejecting head according to a first aspect as a preferred aspect of the present disclosure includes: a plurality of nozzles arranged in a first direction; a first piezoelectric element; a second piezoelectric element; pressure chambers in each of which a pressure for jetting liquid from each of the nozzles is applied when the first piezoelectric element is driven; and detection chambers in each of which a residual vibration of the pressure of the liquid applied in each of the pressure chambers is detected by the second piezoelectric element, wherein, in a plan view, a width of a second active portion in the first direction is larger than a width of a first active portion in the first direction, the second active portion being an active portion of the second piezoelectric element, the first active portion being an active portion of the first piezoelectric element.

According to this aspect, by making the width of the second active portion of the second piezoelectric element in the first direction larger than the width of the first active portion of the first piezoelectric element in the first direction, the amount of strain of the second active portion can be increased, and the voltage output by the second active portion due to the pressure fluctuation in the detection chamber can be increased to improve the detection accuracy of the pressure fluctuation in the detection chambers. In addition, by making the width of the first active portion in the first direction smaller than the width of the second active portion in the first direction, the distance between two first active portions adjacent to each other in the first direction can be increased. Therefore, in the two first active portions adjacent to each other, since the vibration of one first active portion is attenuated until the vibration is transmitted to the other first active portion, it is possible to suppress so-called crosstalk in which the vibration of one first active portion affects the other first active portion.

In a second aspect as a specific example of the first aspect, there are further provided a plurality of the first active portions; a plurality of the second active portions; first individual electrodes individually connected to the plurality of first active portions; and second individual electrodes individually connected to the plurality of second active portions, and a width of each of the second individual electrodes in the first direction is larger than a width of each of the first individual electrodes in the first direction. According to this aspect, the widths of the first active portion and the second active portion can be easily adjusted by the widths of the first individual electrode and the second individual electrode.

In a third aspect as a specific example of the first aspect, when the width of the second active portion in the first direction is W1, a width of an upper surface of each of the detection chambers in the first direction is W2, the width of the first active portion in the first direction is W3, and a width of an upper surface of each of the pressure chambers in the first direction is W4, W1/W2 > W3/W4 is established. According to this aspect, since the second active portion can be provided to have a width as large as possible with respect to the detection chamber having a width limited in the first direction, the amount of strain of the second active portion can be increased to improve the detection accuracy of the residual vibration by the second active portion.

In a fourth aspect as a specific example of the first aspect, in a plan view, when an area of the second active portion is S1, an area of each of the detection chambers is S2, an area of the first active portion is S3, and an area of each of the pressure chambers is S4, S1/S2 > S3/S4 is established. According to this aspect, the second active portion can be provided to have an area as large as possible with respect to the detection chamber having a limited area. Accordingly, the amount of strain of the second active portion can be increased to improve the detection accuracy of the residual vibration by the second active portion. In addition, since the area S3 of the first active portion can be made relatively small with respect to the area S4 of each of the pressure chambers, the amount of deformation of the first active portion can be reduced, and in the two first active portions adjacent to each other, so-called crosstalk in which the vibration of one first active portion affects the other first active portion can be suppressed.

In a fifth aspect as a specific example of the first aspect 1, a plurality of the first active portions are further provided, wherein a distance between the plurality of first active portions in the first direction is larger than the width of each of the first active portions in the first direction. According to this aspect, the distance between the two first active portions adjacent to each other in the first direction can be increased, and crosstalk between the two first active portions can be suppressed.

In a sixth aspect as a specific example of the fifth aspect, a plurality of the second active portions are further provided, and the width of each of the second active portions in the first direction is larger than a distance between the plurality of second active portions in the first direction. According to this aspect, by making the width of each of the second active portions in the first direction larger than the distance between the second active portions adjacent to each other in the first direction, the width of each of the second active portions in the first direction can be made as large as possible. Therefore, it is possible to increase the amount of strain of the second active portions to increase the output voltage, thereby improving the detection accuracy of the residual vibration.

In a seventh aspect as a specific example of the first aspect, each of the detection chambers is smaller than each of the pressure chambers. According to this aspect, by making the detection chambers relatively small, it is possible to reduce the compliance of the detection chambers and to reduce the compliance of the individual flow paths as a whole. Therefore, the first active portions can be driven at a high frequency. When the compliance of the detection chambers is decreased, the second active portions respectively corresponding to the detection chambers are less likely to be strained. However, by increasing the amount of strain by making the width of each of the second active portions in the first direction larger, it is possible to improve the detection accuracy of the residual vibration by the second active portions.

In an eighth aspect as a specific example of the first aspect, a pressure chamber substrate in which the pressure chambers and the detection chambers are provided and a diaphragm disposed on the pressure chamber substrate and defining the pressure chambers and the detection chambers are further provided, and the pressure chamber substrate includes a partition wall provided between the pressure chambers and the detection chambers and defining side surfaces of the pressure chambers and the detection chambers. According to this aspect, since the detection chambers are partitioned from the pressure chambers by the partition wall, it is possible to make it difficult for the second active portions to absorb the pressure fluctuation of the liquid in the pressure chambers due to the first active portions, and thus it is possible to eject the liquid droplets at a high frequency by driving the first active portions at a high frequency.

In a ninth aspect as a specific example of the first aspect, individual flow paths individually communicating with the plurality of nozzles are further provided, and the pressure chambers and the detection chambers are included in the individual flow paths, respectively. According to this aspect, since the pressure chambers and the detection chambers are included in the individual flow paths, respectively, instead of the common flow path, it is possible to individually detect the residual vibration of the pressure chambers by the second active portions. Therefore, it is possible to individually detect, by the second active portions, the ejection failure of the liquid droplets from the nozzles respectively communicating with the pressure chambers.

In a tenth aspect as a specific example of the ninth aspect, each of the individual flow paths includes an individual supply path that supplies the liquid to each of the nozzles and an individual collection path that collects the liquid that has not been jetted from each of the nozzles, and the detection chambers are included in the individual collection paths, respectively. According to this aspect, since the detection chambers are provided in the individual collection paths, respectively, it is possible to shorten the flow path length of each of the individual supply paths, to reduce the pressure loss in the individual supply paths, and to suppress the supply failure of the liquid, compared to a case where the detection chambers are provided in the individual supply paths, respectively. In addition, by providing the detection chambers in the individual collection paths, respectively, the second active portions can individually detect the residual vibration of the pressure chambers, and it is possible to individually detect the ejection failure of the liquid droplets from the nozzles.

A liquid ejecting head according to an eleventh aspect as a preferred aspect of the present disclosure includes: a plurality of nozzles arranged in a first direction; a first piezoelectric element; a second piezoelectric element; pressure chambers in each of which a pressure for jetting liquid from each of the nozzles is applied when the first piezoelectric element is driven; and detection chambers in each of which a residual vibration of the pressure of the liquid applied in each of the pressure chambers is detected by the second piezoelectric element, wherein, in a plan view, an area of a second active portion that is an active portion of the second piezoelectric element is larger than an area of a first active portion that is an active portion of the first piezoelectric element.

According to this aspect, by making the area of the second active portion larger than the area of the first active portion, the area of the second active portion can be made relatively large to increase the amount of strain, and the voltage output from the second active portion can be increased to improve the detection accuracy of the residual vibration by the second active portion. In addition, by making the area of the first active portion smaller, the amount of deformation of the first active portion can be reduced, and in the two first active portions adjacent to each other, so-called crosstalk in which the vibration of one first active portion affects the other first active portion can be suppressed.

A liquid ejecting apparatus according to a twelfth aspect as a preferred aspect of the present disclosure includes: the liquid ejecting head according to any one of the above aspects; and a liquid storage portion that supplies liquid to the liquid ejecting head.

According to this aspect, it is possible to detect the residual vibration due to the pressure change of the liquid in the pressure chambers with high accuracy by the second active portions, and it is possible to detect the ejection failure of the liquid droplets from the nozzles with high accuracy.

What is claimed is:

1. A liquid ejecting head comprising:
a plurality of nozzles arranged in a first direction;
a first piezoelectric element;
a second piezoelectric element;
pressure chambers in each of which a pressure for jetting liquid from each of the nozzles is applied when the first piezoelectric element is driven; and
detection chambers in each of which a residual vibration of the pressure of the liquid applied in each of the pressure chambers is detected by the second piezoelectric element,
wherein, in a plan view, a width of a second active portion in the first direction is larger than a width of a first active portion in the first direction, the second active portion being an active portion of the second piezoelectric element, the first active portion being an active portion of the first piezoelectric element.

2. The liquid ejecting head according to claim 1, further comprising:
a plurality of the first active portions;
a plurality of the second active portions;
first individual electrodes individually connected to the plurality of first active portions; and
second individual electrodes individually connected to the plurality of second active portions,
wherein a width of each of the second individual electrodes in the first direction is larger than a width of each of the first individual electrodes in the first direction.

3. The liquid ejecting head according to claim 1, wherein,
when the width of the second active portion in the first direction is W1, a width of an upper surface of each of the detection chambers in the first direction is W2,
the width of the first active portion in the first direction is W3, and a width of an upper surface of each of the pressure chambers in the first direction is W4, W1/W2 > W3/W4 is established.

4. The liquid ejecting head according to claim 1, wherein,
in a plan view,
when an area of the second active portion is S1, an area of each of the detection chambers is S2, an area of the first active portion is S3, and an area of each of the pressure chambers is S4, S1/S2 > S3/S4 is established.

5. The liquid ejecting head according to claim 1, further comprising
a plurality of the first active portions,
wherein a distance between the plurality of first active portions in the first direction is larger than the width of each of the first active portions in the first direction.

6. The liquid ejecting head according to claim 5, further comprising
a plurality of the second active portions,
wherein the width of each of the second active portions in the first direction is larger than a distance between the plurality of second active portions in the first direction.

7. The liquid ejecting head according to claim 1, wherein
each of the detection chambers is smaller than each of the pressure chambers.

8. The liquid ejecting head according to claim 1, further comprising:
a pressure chamber substrate in which the pressure chambers and the detection chambers are provided; and
a diaphragm disposed on the pressure chamber substrate and defining the pressure chambers and the detection chambers,
wherein the pressure chamber substrate includes a partition wall provided between the pressure chambers and the detection chambers and defining side surfaces of the pressure chambers and the detection chambers.

9. The liquid ejecting head according to claim 1, further comprising
individual flow paths individually communicating with the plurality of nozzles,
wherein the pressure chambers and the detection chambers are included in the individual flow paths, respectively.

10. The liquid ejecting head according to claim 9, wherein
each of the individual flow paths includes an individual supply path that supplies the liquid to each of the nozzles and an individual collection path that collects the liquid that has not been jetted from each of the nozzles, and
the detection chambers are included in the individual collection paths, respectively.

11. A liquid ejecting head comprising:
a plurality of nozzles arranged in a first direction;
a first piezoelectric element;
a second piezoelectric element;
pressure chambers in each of which a pressure for jetting liquid from each of the nozzles is applied when the first piezoelectric element is driven; and
detection chambers in each of which a residual vibration of the pressure of the liquid applied in each of the pressure chambers is detected by the second piezoelectric element,
wherein, in a plan view, an area of a second active portion that is an active portion of the second piezoelectric element is larger than an area of a first active portion that is an active portion of the first piezoelectric element.

12. A liquid ejecting apparatus comprising:
the liquid ejecting head according to claim 1; and
a liquid storage portion that supplies liquid to the liquid ejecting head.
